(19) United States
(12) Patent Application Publication
(10) Pub. No.: US 2022/0397561 A1
(43) Pub. Date: Dec. 15, 2022

(54) CATIONIC POLYMER DETECTION SYSTEM, INDICATOR WIPE PRODUCT AND METHODS THEREOF

(71) Applicant: SRFC BIO, INC., DALLAS, TX (US)

(72) Inventors: Parham Asgari, Dallas, TX (US); Robert Godfroid, McKinney, TX (US); Jie Fang, Ammon, ID (US); Devin Whorton, Irving, TX (US); Maha El-Sayed, Fremont, CA (US)

(73) Assignee: SRFC BIO, INC., DALLAS, TX (US)

(21) Appl. No.: 17/829,668

(22) Filed: Jun. 1, 2022

Related U.S. Application Data
(60) Provisional application No. 63/195,580, filed on Jun. 1, 2021.

(51) Int. Cl. G01N 31/22; G01N 21/29; G01N 30/95

(52) U.S. Cl. CPC G01N 31/22; G01N 21/29; G01N 30/95

(57) ABSTRACT

Systems, indicator wipe product, and methods thereof used to detect the presence of cationic polymer residues on a surface are described. In various embodiments, the cationic polymer to be detected comprises a quaternary silane residual antimicrobial. The indicator wipe may comprise a woven, nonwoven, or double-knit fabric, cotton, functional cellulose, or open cell foam material substrate impregnated with an aqueous dye solution comprising a sulfonephthalein dye. The indicator wipe may be configured to differentiate between traditional monomer quaternary ammonium compounds and cationic polymers such as quaternary silane compounds used in residual antimicrobial coatings by color changes on the indicator wipe and by observing if cationic-dye complexes diffuse by chromatography on the indicator wipe.

### CROSS-REFERENCE TO RELATED APPLICATIONS

This application claims priority to and the benefit of U.S. Provisional Patent Application Ser. No. 63/195,580 filed Jun. 1, 2021, entitled “Cationic Polymer Detection System, Indicator Wipe Product and Methods Thereof,” which is incorporated by reference herein in its entirety.

The present disclosure generally relates to qualitative chemical analysis and in particular to systems, product, and methods for detecting the presence of cationic polymer residues, including polymeric quaternary silanes, on various surfaces.

### BACKGROUND

Many diverse antimicrobial compositions have recently been developed or rediscovered and improved in an effort to mitigate infectability of emerging pathogens. These compositions range from contact disinfectants and sanitizers to compositions capable of forming surface coatings exhibiting residual antimicrobial efficacy. The multitude of compositions feature a cacophony of active ingredients, such as for example, non-silane or “traditional” monomeric quaternary ammonium compounds (“quats”), sodium hypochlorite, hydrogen peroxide, isopropyl alcohol, chlorine dioxide, organosilanes, aldehydes, triclocarban, triclosan, biguanides, poly(hexamethylene biguanide chloride), quaternary ammonium/phosphonium polymers, N-halamine polymers, metals, phenolics, and so forth. See, for example, G. McDonnell, et al., “Antiseptics and Disinfectants: Activity, Action and Resistance,” Clin. Microbiol. Rev., 12(1), 147-179, 1999 and L. Timofeeva, et al., “Antimicrobial polymers: Mechanism of action, factors of activity, and application,” App. Microbiol. Biotechnology, DOI 10.1007/s00253-010-2920-9, Springer-Verlag, 2010.

Unfortunately, there is no easy way to determine whether a surface has even been cleaned with an antimicrobial composition, and perhaps not sufficiently rinsed, or if a surface has a residual antimicrobial coating, such as a cationic polymer, purposely left behind. Further, there is no practical way to determine what chemicals might have been used on a surface or that remain on a surface. As such, there is no simple way to test a surface out in the field, such as inside establishments, for the presence of a residual antimicrobial coating, to determine the nature of that coating, or to determine if the coating has been compromised and that a surface needs to be recoated. For example, U.S. Application Publication 2019/0175776 (Ha, et al.) discloses a method based on pH indicators capable of distinguishing only between a traditional non-silane quaternary ammonium compound, hydrogen peroxide, and chlorine bleach, but is not capable of distinguishing between cationic polymers, such as quaternary silane compounds, as might be found in residual antimicrobial thin-film coatings, and ordinary quaternary ammonium compounds, such as used for contact sanitization/disinfection and not used for residual antimicrobial coatings. Further, U.S. Pat. No. 9,170,205 (Burns, et al.) discloses an indicator kit configured to detect the presence of a quaternary ammonium compound disinfectant on a surface; however the disclosed kit is incapable of distinguishing between ordinary quaternary ammonium compounds and cationic polymer compounds.

As such, there is a continuing need for qualitative analytical systems and methods usable to determine the presence of, and the nature of, residual antimicrobial coatings on surfaces. In particular, rapid chemical test methods are needed that can be used to determine what antimicrobial agents, if any, remain on a surface that was previously cleaned and/or treated.

### SUMMARY OF INVENTION

In various embodiments, a cationic polymer detection system, indicator wipe product, indicator swab product and methods thereof are disclosed. In various embodiments, the cationic polymer detection system is capable of detecting a quaternary silane present on a surface. In various embodiments, the indicator wipe comprises a woven, nonwoven, or double-knit substrate wetted with an aqueous dye solution comprising a sulfonephthalein dye. In various embodiments, the indicator swab comprises a woven, nonwoven, double-knit fabric, cotton, functionalized cellulose, or open cell foam material attached to a stick to form a swab that is pre-saturated with an indicator solution. In various embodiments, the indicator swab comprises a woven, nonwoven, double-knit fabric, cotton, functionalized cellulose, or open cell foam material attached to a stick to form a swab that is moistened with alcohol or water to collect surface residue and the swab is then placed into a solution of indicator dye and monitored for a color change indicating the presence of a target active ingredient or by the utilization of spectrophotometric equipment. In various embodiments, the aqueous dye composition is operable to form an ionic complex between the sulfonephthalein dye and the cationic polymer, and the rate of chromatographic diffusion of the complex on the substrate distinguishes a polymeric cation-dye complex (such as formed from a polymerized quaternary silane) from a monomeric quaternary ammonium compound-dye complexes (such as formed from an ordinary quat).

In various embodiments, an indicator wipe is disclosed for detecting the presence of and determining the type of cationic polymer on a surface. The indicator wipe comprises: a substrate capable of supporting aqueous chromatography; and an aqueous dye composition impregnated therein, the aqueous dye composition comprising a sulfonephthalein dye, wherein the aqueous dye composition is operable to produce a cationic polymer-sulfonephthalein dye complex having a visible color, wherein the indicator wipe is configured to be wiped over the surface for detection of the presence of the cationic polymer on the surface by the visible color, and wherein the indicator wipe is configured to determine the type of cationic polymer present on the surface by the chromatography.

In various embodiments, the pH of the aqueous dye composition impregnated into the substrate is from about 1 to about 3.

In various embodiments, the pH of the aqueous dye composition impregnated into the substrate is from about 4 to about 5.

In various embodiments, the substrate comprises a woven, nonwoven, or double-knit fabric, cotton, functionalized cellulose, or open cell foam material.

In various embodiments, the substrate is a polyester nonwoven or a double-knit filament polyester cloth.

In various embodiments, the substrate comprises a woven, nonwoven, double-knit fabric, cotton, functionalized cellulose, or open cell foam material attached to a stick to form a swab.

In various embodiments, the substrate is polyester nonwoven or double-knit filament polyester cloth attached to a stick to form a swab.

In various embodiments, the substrate comprises a woven, nonwoven, or double-knit fabric, cotton, functionalized cellulose, or open cell foam material forming a nib attached to a handheld instrument marker style or pen style shaped body.

In various embodiments, the substrate is polyester nonwoven or double-knit filament polyester cloth forming a nib attached to a handheld instrument marker style or pen style shaped body.

In various embodiments, the sulfonephthalein dye is selected from the group consisting of bromophenol blue, bromocresol purple, bromocresol green, bromothymol blue, cresol red, chlorophenol red, m-cresol purple, thymol blue, alizarin red S, and combinations thereof.

In various embodiments, the aqueous dye composition further comprises an azosulfonate, an azocarboxylate, or a bisazosulfonate dye.

In various embodiments, the azosulfonate, an azocarboxylate, or a bisazosulfonate dye is selected from the group consisting of alizarin yellow R, methyl red, methyl orange, metanil yellow, benzopurpurin 4B, β-naphthol violet, orange II, congo red, yellow 2G, and combinations thereof.

In various embodiments, the substrate is impregnated with the aqueous dye composition at about 0.1 g aqueous dye composition/in² substrate to about 0.5 g aqueous dye composition/in² substrate.

In various embodiments, the sulfonephthalein dye is bromophenol blue, bromocresol purple, bromothymol blue, or chlorophenol red, and wherein the aqueous dye composition has a pH of about 2.

In various embodiments, cationic polymer to be detected comprises a quaternary silane.

In various embodiments, a method of detecting the presence of and determining the nature of a cationic compound on a surface is described. The method comprises: contacting a portion of an indicator wipe with the surface, the indicator wipe comprising: a substrate capable of supporting aqueous chromatography; and an aqueous dye composition impregnated therein, the aqueous dye composition comprising a sulfonephthalein dye, and wherein the aqueous dye composition is operable to produce a cationic compound-sulfonephthalein dye complex having a visible color; and visually observing: (i) whether the visible color develops on the portion of the indicator wipe contacted with the surface, indicating the presence of the cationic compound on the surface; and (ii) whether the visible color moves on the substrate by aqueous chromatography into a region adjacent to the portion of the indicator wipe contacted with the surface, wherein movement indicates that the cationic compound is monomeric and wherein no movement indicates that the cationic compound is polymeric.

In various embodiments, the contacting comprises wiping a central region of the indicator wipe on the surface.

In various embodiments, no blue to blue-violet visible color on the portion of the indicator wipe contacted with the surface indicates an absence of the cationic compound on the surface.

In various embodiments, a blue to blue-violet visible color on the portion of the indicator wipe contacted with the surface indicates the presence of the cationic compound on the surface.

In various embodiments, movement of the blue to blue-violet visible color on the substrate by aqueous chromatography into a region adjacent to the portion of the indicator wipe contacted with the surface indicates that the cationic compound present on the surface is monomeric.

In various embodiments, the cationic compound present on the surface comprises a non-silane quaternary ammonium compound.

In various embodiments, no movement of the blue to blue-violet visible color on the substrate by aqueous chromatography into a region adjacent to the portion of the indicator wipe contacted with the surface indicates that the cationic compound present on the surface is polymeric.

In various embodiments, the polymeric cationic compound present on the surface comprises a quaternary silane.

In various embodiments, the quaternary silane present on the surface comprises dimethyloctadecyl[3-(trihydroxysilyl)propyl]ammonium chloride.

In various embodiments, an intensity of the visible color is dependent on the pH of the aqueous dye composition.

In various embodiments, the substrate comprises a polyester nonwoven or a double-knit filament polyester cloth.

In various embodiments, the sulfonephthalein dye is selected from the group consisting of bromophenol blue, bromocresol purple, bromocresol green, bromothymol blue, cresol red, chlorophenol red, m-cresol purple, thymol blue, alizarin red S, and combinations thereof.

In various embodiments, the aqueous dye composition further comprises an azosulfonate, an azocarboxylate, or a bisazosulfonate dye.

In various embodiments, the azosulfonate, an azocarboxylate, or a bisazosulfonate dye is selected from the group consisting of alizarin yellow R, methyl red, methyl orange, metanil yellow, benzopurpurin 4B, β-naphthol violet, orange II, congo red, yellow 2G, and combinations thereof.

In various embodiments, an indicator wipe for detecting the presence of and determining the type of a quaternary ammonium compound on a surface is described. The indicator wipe comprises: a substrate capable of aqueous chromatography; and an aqueous dye composition impregnated therein, the aqueous dye composition comprising a sulfonephthalein dye, wherein the aqueous dye composition is operable to produce a quaternary ammonium-sulfonephthalein dye complex having a visible color, wherein the indicator wipe is configured to be wiped over the surface for detection of the presence of the quaternary ammonium compound on the surface by the visible color, and wherein the indicator wipe is configured to determine the type of quaternary ammonium compound present on the surface by the chromatography.

In various embodiments, the pH of the aqueous dye composition impregnated into the substrate is from about 1 to about 3.

In various embodiments, the pH of the aqueous dye composition impregnated into the substrate is from about 4 to about 5.

In various embodiments, the substrate comprises a woven, nonwoven, or double-knit fabric, cotton, functionalized cellulose, or open cell foam material.

In various embodiments, the substrate is polyester nonwoven or double-knit filament polyester cloth.

In various embodiments, the substrate comprises a woven, nonwoven, or double-knit fabric, cotton, functionalized cellulose, or open cell foam material attached to a stick to form a swab.

In various embodiments, the substrate is polyester nonwoven or double-knit filament polyester cloth attached to a stick to form a swab.

In various embodiments, the substrate comprises a woven, nonwoven, or double-knit fabric, cotton, functionalized cellulose, or open cell foam material forming a nib attached to a handheld instrument marker style or pen style shaped body.

In various embodiments, the substrate is polyester nonwoven or double-knit filament polyester cloth forming a nib attached to a handheld instrument marker style or pen style shaped body.

In various embodiments, the sulfonephthalein dye is selected from the group consisting of bromophenol blue, bromocresol purple, bromocresol green, bromothymol blue, cresol red, chlorophenol red, m-cresol purple, thymol blue, alizarin red S, and combinations thereof.

In various embodiments, the aqueous dye composition further comprises an azosulfonate, an azocarboxylate, or a bisazosulfonate dye.

In various embodiments, the azosulfonate, an azocarboxylate, or a bisazosulfonate dye is selected from the group consisting of alizarin yellow R, methyl red, methyl orange, metanil yellow, benzopurpurin 4B, β-naphthol violet, orange II, congo red, yellow 2G, and combinations thereof.

In various embodiments, the substrate is impregnated with the aqueous dye composition at about 0.1 g aqueous dye composition/in² substrate to about 0.5 g aqueous dye composition/in² substrate.

In various embodiments, the sulfonephthalein dye is bromophenol blue, bromocresol purple, bromothymol blue, or chlorophenol red, and wherein the aqueous dye composition has a pH of about 2.

In various embodiments, a method of detecting the presence of and determining the nature of a quaternary ammonium compound on a surface is described. The method comprises: contacting a portion of an indicator wipe with the surface, the indicator wipe comprising: a substrate capable of aqueous chromatography; and an aqueous dye composition impregnated therein, the aqueous dye composition comprising a sulfonephthalein dye, and wherein the aqueous dye composition is operable to produce a quaternary ammonium-sulfonephthalein dye complex having a visible color; and visually observing: (i) whether the visible color develops on the portion of the indicator wipe contacted with the surface, indicating the presence of the quaternary ammonium compound on the surface; and (ii) whether the visible color moves on the substrate by aqueous chromatography into a region adjacent to the portion of the indicator wipe contacted with the surface, wherein movement indicates that the quaternary ammonium compound is monomeric and wherein no movement indicates that the quaternary ammonium compound is polymeric.

In various embodiments, the contacting comprises wiping a central region of the indicator wipe on the surface.

In various embodiments, no blue to blue-violet visible color on the portion of the indicator wipe contacted with the surface indicates an absence of the quaternary ammonium compound on the surface.

In various embodiments, a blue to blue-violet visible color on the portion of the indicator wipe contacted with the surface indicates the presence of the quaternary ammonium compound on the surface.

In various embodiments, movement of the blue to blue-violet visible color on the substrate by aqueous chromatography into a region adjacent to the portion of the indicator wipe contacted with the surface indicates that the quaternary ammonium compound present on the surface is monomeric.

In various embodiments, the quaternary ammonium compound present on the surface comprises a non-silane quaternary ammonium compound.

In various embodiments, no movement of the blue to blue-violet visible color on the substrate by aqueous chromatography into a region adjacent to the portion of the indicator wipe contacted with the surface indicates that the quaternary ammonium compound present on the surface is polymeric.

In various embodiments, the quaternary ammonium compound present on the surface comprises dimethyloctadecyl[3-(trihydroxysilyl)propyl]ammonium chloride.

In various embodiments, an intensity of the visible color is dependent on the pH of the aqueous dye composition.

In various embodiments, the substrate comprises a woven, nonwoven, or double-knit fabric, cotton, functionalized cellulose, or open cell foam material.

In various embodiments, the substrate comprises a polyester nonwoven or a double-knit filament polyester cloth.

In various embodiments, the substrate comprises a woven, nonwoven, double-knit fabric, cotton, functionalized cellulose, or open cell foam material attached to a stick to form a swab.

In various embodiments, the substrate is polyester nonwoven or double-knit filament polyester cloth attached to a stick to form a swab.

In various embodiments, the substrate comprises a woven, nonwoven, or double-knit fabric, cotton, functionalized cellulose, or open cell foam material forming a nib attached to a handheld instrument marker style or pen style shaped body.

In various embodiments, the substrate is polyester nonwoven or double-knit filament polyester cloth forming a nib attached to a handheld instrument marker style or pen style shaped body.

### BRIEF DESCRIPTION OF THE DRAWING FIGURES

The subject matter is pointed out with particularity and claimed distinctly in the concluding portion of the specification. A more complete understanding, however, may best be obtained by referring to the detailed description and claims when considered in connection with the following drawing figures:

FIG. 1 illustrates a method wherein an indicator wipe is bunched up to expose only a small, centrally located region, and then wiped across a surface to pick up chemicals that may be present on the surface, in accordance with various embodiments; and

FIG. 2 illustrates the indicator wipe, having picked up surface chemicals, during various stages of reactive dye chemistry and chromatography as part of a method for detecting the presence of certain cationic polymers and to distinguish cationic polymers from monomeric quaternary ammonium compounds, in accordance with various embodiments.

FIGS. 3A-3C illustrate various embodiments of the indicator wipe and detection methods disclosed herein.

### DETAILED DESCRIPTION

The detailed description of exemplary embodiments makes reference to the accompanying drawings, which show exemplary embodiments by way of illustration and their best mode. While these exemplary embodiments are described in sufficient detail to enable those skilled in the art to practice the invention, it should be understood that other embodiments may be realized and that logical, chemical, and mechanical changes may be made without departing from the spirit and scope of the inventions. Thus, the detailed description is presented for purposes of illustration only and not of limitation. For example, unless otherwise noted, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

In various embodiments, a cationic polymer detection system is disclosed. The system comprises an indicator wipe product and methods of use thereof. The indicator wipe comprises a woven, nonwoven, or double-knit substrate wetted with an aqueous dye solution adjusted to a particular pH target. In various embodiments, the cationic polymer to be detected on a surface comprises a quaternary silane antimicrobial present in a polymerized form.

In various embodiments, the aqueous dye solution on the substrate may comprise at least one sulfonephthalein dye. In various embodiments, the aqueous dye solution on the substrate may comprise at least one sulfonephthalein dye (single-dye system) and at least one sulfonated or carboxylated azo dye (two-dye system).

In various embodiments, a chemical residue on a surface is analyzed qualitatively for the presence of certain antimicrobial substances. In various embodiments, methods for detecting the presence of a cationic polymer, such as a quaternary silane antimicrobial, present on a surface in a polymerized form is disclosed. In various embodiments, methods are described for qualitatively analyzing residue on a surface and for distinguishing between cationic polymers and ordinary monomeric quaternary ammonium disinfectants on a surface.

In various embodiments, an indicator wipe is first wiped across a portion of a surface to be analyzed and then various changes in the substrate due to reactive dye chemistry and chromatography are observed and interpreted.

In various embodiments, the indicator wipe is bunched up prior to wiping the surface such that residue present on the surface is picked up in only a central region of the indicator wipe. In this way the chromatography that momentarily ensues creates one or more halos radiating out from the central region.

In various embodiments, the color changes within the central region of the indicator wipe, and the one or more colors that develop and radiate out as halos from the central region due to the ensuing chromatography, are interpreted, and a conclusion can then be made as to the type of cleaning, disinfecting or residual sanitizing substances present on the surface. The colors that may or may not develop in the various regions of the substrate are due to the presence of at least one sulfonephthalein dye and, optionally, at least one sulfonated or carboxylated azo dye, that react with cationic species such as antimicrobial compounds at certain pH values.

Without the possibility for chromatography on the substrate of the indicator wipe, a conclusion as to the type of cleaning, disinfecting or residual sanitizing substances may be present on a surface would not be possible.

In various embodiments, a cationic polymer detection system in accordance with the present disclosure is capable of distinguishing cationic polymers from ordinary monomeric quaternary ammonium compounds. As such, the system comprising an indicator wipe and methods of use thereof can detect whether a surface was coated with a cationic polymer, such as a polymerized quaternary silane antimicrobial, or if the surface was instead simply disinfected with a monomeric quaternary ammonium compound.

In various embodiments, a cationic polymer detection system in accordance with the present disclosure is capable of distinguishing coatings comprising a mixture of quaternary silane compound plus an alkaline amino silane compound, such as 3-aminopropyltriethoxysilane, from coatings comprising only a quaternary silane compound and no amino silane compound. As such, the system comprising an indicator wipe and methods of use thereof can detect whether a surface was coated with a quaternary silane antimicrobial composition that also may comprise an alkaline amino silane compound or instead coated with a quaternary silane antimicrobial composition that does not further comprise an alkaline amino silane compound.

Definitions and Interpretations:

As used herein, the term “cationic polymer” takes on its ordinary meaning in chemistry and refers to a positively charged macromolecule having one or more positively charged groups, comprising repeating chemical units referred to in chemistry as “monomers.” Cationic polymers for detection herein may comprise any type of linear, branched, homopolymer, or copolymer (block, random, etc.), with any number of monomers and any mixture of monomer types. The cationic group(s) on the “backbone” of the polymer may comprise any positively charged functional group in the backbone structure or appended to the backbone structure, such as a protonated amine or imine group, biguanides, a quaternary ammonium group, or a phosphonium group, amongst others. As discussed in detail herein, the systems, indicator wipe, and methods according to the present invention are operable to detect cationic polymer residues on surfaces and to distinguish cationic polymer residues from ordinary, monomeric quaternary ammonium compounds. In various embodiments, a cationic polymer herein comprises a quaternary silane that is present as a polymer due to a reactive silane group, as defined below. In other embodiments, cationic polymers to be detected by the systems, product and methods herein include various protonated or quaternized polymers, such as, but not limited to, poly(hexamethylene biguanide chloride), polyaminopropyl biguanide, polyethylene containing pendent biguanide groups, polymethacrylate containing pendent biguanide groups, polyethylene containing pendent ethyl dimethyl benzyl ammonium chloride groups, polymethacrylate containing pendent ethyl dimethyl benzyl ammonium chloride groups, co-polymers of 2-chloroethylvinyl ether and vinylbenzylchloride with immobilized ammonium or phosphonium salts, N-halamines and various cationic polyelectrolytes such as poly(lysine) hydrochloride or hydrobromide, poly(allylamine) hydrochloride or hydrobromide, poly(ethylenimine) (PEI), quaternary ammonium polysalts (polyionenes, quaternized poly(vinylpyridine), and various protonated polyamines such as polytriazines, polypyrrolones, polyimides, polyamide-imides, and polybenzimidazoles. In various embodiments, a cationic polymer herein may be referred to as a “polycation.”

As used herein, the term “quaternary silane” refers to an organosilane of general formula (R¹O)₃Si—R²—Y, wherein R¹ is H, methyl, ethyl, or a C₃-C₆ straight-chained, branched or cyclic alkyl group, with the proviso that the organosilane (R¹O)₃Si—R²—Y having R¹═C₃-C₆ straight-chained, branched or cyclic alkyl group is capable of hydrolyzing in an aqueous environment to (HO)₃Si—R²—Y whereby polymerization ensues; R² is a bivalent linker; Y=⁺—N(CH₃)₂(C₁₈H₃₇)X⁻; ⁺—N(CH₃)₂(C₁₄H₂₉)X⁻; or ⁺—N(C₁₀H₂₁)₂(CH₃)X₋; and X⁻=halide, sulfate, nitrate, phosphate, carbonate, organic sulfonate, organic carbonate, BF₄⁻, or ClO₄⁻. In various embodiments, a quaternary silane for detection by the system may comprise at least one of dimethyloctadecyl[3-(trihydroxysilyl)propyl]ammonium chloride, dimethyloctadecyl[3-(trimethoxysilyl)propyl]ammonium chloride, dimethyloctadecyl[3-(triethoxysilyl)propyl]ammonium chloride, dimethyltetradecyl[3-(trihydroxysilyl)propyl]ammonium chloride, dimethyltetradecyl[3-(trimethoxysilyl)propyl]ammonium chloride, dimethyltetradecyl[3-(triethoxysilyl)propyl]ammonium chloride, didecylmethyl[3-(trihydroxysilyl)propyl]ammonium chloride, didecylmethyl[3-(trimethoxysilyl)propyl]ammonium chloride, didecylmethyl[3-(triethoxysilyl)propyl]ammonium chloride.

Quaternary silanes for detection herein form a subgroup of cationic polymers in that the above-mentioned, and other related alkoxy or hydroxy silanes, have a propensity to polymerize in aqueous environments. The polymerization comprises condensation to form Si—O—Si bonds by loss of water or alcohol. This polymerization is thoroughly described in A. Issa, et al., “Kinetics of Alkoxysilanes and Organoalkoxysilanes Polymerization: A Review,” Polymers, 11, 537 (2019). Therefore, it is not the presence of the quaternary ammonium substituent in the quaternary silanes to be detected herein that cause polymerization, but rather the presence of a reactive silane group comprising an alkoxy or hydroxy group directly bonded to silicon. It should be noted that the precise polymeric structure of a quaternary silane herein is not important, but instead that it is a polymeric species that exhibits poor or no migratory ability on a nonwoven, woven or double-knit chromatographic substrate when complexed to a negatively charged dye molecule. The silane polymer may be characterized as a homopolymer, copolymer, or cross-linked polymer, or mixtures of these. A cationic polymer comprising a quaternary silane for detection herein is distinguishable from a traditional, non-silane quaternary ammonium compound because the later is not capable of polymerization and exists only as monomeric species in solution.

As used herein, the term “residual antimicrobial coating” refers to a dry, thin-film coating on a surface that is capable of exhibiting residual antimicrobial efficacy. In various embodiments, the residual antimicrobial coating to be detected on a surface comprises a cationic polymer, such as a polyhexanide in a protonated form. In various examples herein, a residual antimicrobial coating to be qualitatively detected on a surface, and importantly, to be distinguished from ordinary non-silane quaternary ammonium compound residues, may comprise at least one quaternary silane as defined above. Such coatings may also comprise other organosilanes that have no quaternary ammonium substituents. Such coatings to be detected may also have been formed from coating compositions comprising at least one organic amine. Residual antimicrobial coatings may have been formed on a surface by disposition of a residual antimicrobial coating composition on the surface followed by drying. Such coatings are so thin they are typically not observable by the naked eye nor scrapable by any sort of sharpened tool. Coatings to be detected by the systems, products, and methods include, for example, those residual antimicrobial coatings described in U.S. Pat. Nos. 10,980,236 and 10,993,441, and in U.S. patent application Ser. Nos. 17/177,850 and 17/200,245. Each of these patents and patent applications is assigned to Allied Bioscience, Inc. and each incorporated herein by reference in its entirety for all purposes. In various embodiments, surface coatings comprising a combination of dimethyloctadecyl[3-(trihydroxysilyl)propyl]ammonium chloride, 3-chloropropyltrimethoxysilane (3-CPTMS), and triethanolamine are detected by the systems, products, and methods. In various embodiments, surface coatings comprising a combination of dimethyloctadecyl[3-(trihydroxysilyl)propyl]ammonium chloride, 3-chloropropyltrimethoxysilane (3-CPTMS), 3-aminopropyltriethoxysilane (3-APTES), and triethanolamine are detected by the systems, products, and methods. In various embodiments, these two surface coatings are distinguished from one another by the systems, products, and methods, and each coating is distinguished from ordinary non-silane quaternary ammonium compound residues by the systems, products, and methods.

As used herein, the terms “traditional quaternary ammonium compound,” “monomeric quaternary ammonium compound,” or “non-silane quaternary compound” interchangeably refer to a monomeric molecule comprising a quaternary ammonium functionality, but not containing any reactive silicon atoms capable of hydrolysis/polymerization, and are thus distinguishable from the above mentioned “cationic polymer” genus of compounds and “quaternary silane” subgenus of compounds. Typical non-silane quaternary compounds are of the formula ⁺N(R³R⁴R⁵R⁶)X⁻, wherein the four substituents bonded to nitrogen, R³, R⁴, R⁵, and R⁶, are independently alkyl, benzyl or alkyl benzyl, and X⁻=halide, sulfate, nitrate, phosphate, carbonate, organic sulfonate, organic carbonate, BF₄⁻, or ClO₄⁻, typically chloride. The non-silane quaternary compounds are generally antimicrobial and are found in countless sanitizers and disinfectants. These quaternary ammonium antimicrobials (also known as “quaternary ammonium compounds” or simply “quats”) are supplied by Lonza, Stepan, and Pilot (having acquired the quats from Mason Chemical) and others, under various brand names, such as Bardac® and Barquat® from Lonza, BTC® and. Stepanquat® from Stepan, and Mason® from Pilot. It should be noted that most of these quaternary compounds are mixtures of active materials in order to achieve broad spectrum antimicrobial efficacy, and most of these further comprise mixtures of alkyl chain lengths. These compounds are referred to as monomeric and are entirely distinguishable (structurally, and by the detection methods herein) from cationic polymers such as quaternary silanes as defined above.

In various embodiments, a non-silane quaternary compound may comprise BTC®-1210 (mixture of n-alkyldimethylbenzyl ammonium chloride and didecyldimethyl ammonium chloride); BTC®-1010 (didecyldimethyl ammonium chloride); BTC®-2125M (mixture of n-alkyldimethylbenzyl ammonium chloride and n-alkyl dimethylethylbenzyl ammonium chloride); Stepanquat® 2125M (mixture of n-alkyldimethylbenzyl ammonium chloride and n-alkyl dimethylethylbenzyl ammonium chloride); BTC®-885 (mixture of n-alkyldimethylbenzyl ammonium chloride and dialkyldimethyl ammonium chloride); BTC®-8358 (n-alkyldimethylbenzyl ammonium chloride); Bardac® 205M (mixture of alkyldimethylbenzyl and dialkyldimethyl ammonium chloride); Barquat® MB-80 (alkyldimethylbenzyl ammonium chloride); Mason® CS 125 (50% active alkyldimethylbenzyl ammonium chloride, with a distribution of chain lengths C12 67%, C14 25%, C16 7%, and C18 1%); Mason® CS-15M and 24M (mixture of dialkyldimethyl ammonium chlorides and alkyldimethylbenzyl ammonium chloride); and Mason® CS-425 (50% active alkyldimethylbenzyl ammonium chloride having a chain length distribution of C12 40%, C14 50%, C16 10%, and C16 10%). This list is not meant to be limiting in any sense, but is instead intended to show the breadth of non-silane, monomeric quaternary compounds that might be found in various surface sanitizers and disinfectants used to sanitize and/or disinfect surfaces, and that may be left on the surface after use such as if the product comprising the ordinary non-silane quat is used as a “no-rinse” sanitizer, or if the surface was not properly rinsed afterwards.

As used herein, the term “cationic compound” takes on its ordinary meaning in chemistry as a positively charged molecular species. Herein, this includes both cationic polymers, such as quaternary silanes, along with non-silane, monomeric quaternary ammonium compounds, both defined herein above. In various embodiments, the systems, indicator wipe product, and methods thereof are used to identify the presence of and the nature of a cationic compound on a surface. Meaning that, in various embodiments herein, what is to be identified on a surface is cationic, but the cationic residue may be (i) a cationic polymer that is not a quaternary silane, or (ii) a cationic polymer that is a quaternary silane, present in a polymeric form, or (iii) an ordinary, non-silane monomeric quaternary ammonium compound (i.e., a quat).

As used herein, the term “substrate” refers to a sheet or swatch of absorbent material having sufficient absorptive capacity to hold at least some liquid impregnated therein, and which is capable of functioning as a chromatography media for the separation of water-soluble compounds. In various embodiments, a substrate is chosen for its capability of performing aqueous chromatographic separations, and in particular for an ability to separate ionic complexes formed between a negatively charged dye molecule and a positively charged quaternary ammonium compound. The familiar art of tie-dying exemplifies how a 100% cotton, 100% polyester, or 50% cotton/50% polyester fabric can function as a chromatography medium, whereby various dye colors are wicked out into patterns. For use herein, a woven, nonwoven, or double-knit fabric swatch may be used as the substrate for the indicator wipe. In various embodiments, cotton, functionalized cellulose, or open cell foam materials may be used as the substrate in the form of an indicator wipe. In various embodiments, a substrate is chosen for its ability to support aqueous chromatographic separation of cationic polymer-dye complexes from monomeric quaternary ammonium compound-dye complexes. In various embodiments, a substrate is chosen for its ability to collect and retain surface residue from a surface and then placed into a container of indicator solution. In various embodiments, a substrate is chosen for its ability to wick solution through the indicator substrate material to support aqueous chromatographic separation of active dye complexes.

A substrate for use herein is typically quite thin, such as on the order of less than 100 mil thickness (<0.10 inches). In various examples, a substrate is less than about 50 mils thick, less than about 20 mils thick, or less than about 10 mils thick. Thickness may also be reflected in the basis weight of a substrate, which is a measure of the density of the fabric, which necessarily factors in the weight of the substrate. Basis weight of a fabric substrate is expressed in ounces/square yard, or “osy” units of measurement. For use herein, a substrate will typically have a basis weight of between about 0.5 osy and about 40 osy. In some examples, a substrate for use herein has a basis weight of less than about 10 osy, and in some instances, less than about 5 osy. Substrates for use herein should be colorless (i.e., white), or at least no more colored than off-white. For example, a nonwoven may be naturally white, or may be bleached to a white color, or may be somewhat off-white due to the presence of natural materials. Natural substrates for use herein would not be purposely dyed, nor would synthetic substrates be purposely colored. By using white to only off-white substrates, colors, color changes, and chromatography on the substrate can be easily observed.

Substrates for use herein may comprise natural materials (e.g. paper, cotton, cellulosic, functionalized cellulose), synthetic materials (e.g., polyolefin like polyethylene or polypropylene, or polyester), or combinations of the two (e.g. pulp wetlaid or airlaid onto a plastic webbing, open cell foam). In various embodiments, a substrate may comprise a woven or a nonwoven fabric. In other embodiments, a substrate may comprise a thin sheet of porous plastic, such as obtained by sintering plastic particles in a mold or during rolling or extrusion. In the case of thin flexible porous plastic sheets, the substrate is not considered fabric at all. Woven fabric substrates may be synthetic or natural, examples including but not limited to woven polyester (synthetic) and woven cotton (natural) or blends thereof. Woven substrates may resemble the materials commonly seen in clothing, (polyester, cotton, cotton/poly, spandex, and the like). Nonwovens are more prevalent in the wet wipes industry. These materials comprise randomly or directionally laid fibers. Typical nonwovens that find use as substrates herein include various meltblown, spunbond, airlaid, wetlaid and needlepunch fabric substrates, such as available from the Kimberly-Clark Company, Atlanta, Ga. or Deitsch Plastic, West Haven, Conn. Of particular importance are polyethylene, polypropylene, polyester, acrylic, rayon, 4DG polyester, and blends of these plastic materials in the form of meltblown, spunbond, airlaid, wetlaid and needlepunch nonwoven fabric. Also of importance are the unidirectional nonwoven fabrics, such as those comprising polyethylene filaments laid parallel in a resin matrix. Natural substrates are available from the Fort James Corporation, acquired by Georgia Pacific LLC and now a subsidiary of Koch Industries. The substrates available from Fort James include pulp-based substrates.

In various embodiments, a woven, nonwoven, or double-knit substrate made of at least some synthetic material, and that can act as a chromatographic media, are preferred. For example, nonwoven polyester and double-knit polyester substrates were found highly effective for indicator wipes, whereas most cellulose-based substrates were found to be ineffective at expressing aqueous chromatography and thus were not usable as substrates for indicator wipes. In various embodiments, nonwoven polyester gauze sponge and double-knit filament polyester cloth are particularly useful for indicator wipes.

As used herein, the term “indicator wipe” refers to a product, and more specifically to an article of manufacture comprising a substrate, per the above description, at least partially wetted with an aqueous dye solution. The level of wetting is detailed herein, but in various embodiments, the wetting of the substrate can range from a partial wetting to complete saturation of the substrate to its limits of absorbance and is optimized such that the indicator wipe is capable of picking up chemical residues from a surface even though the surface and the residues to detect are dry. In various embodiments, an indicator wipe may comprise a substrate attached to a stick to form a swab. In various embodiments, an indicator wipe may comprise a substrate forming a nib attached to a handheld instrument marker style or pen style shaped body. In some embodiments, an indicator wipe in accordance with the present disclosure will at least appear physically similar to many cleaning and disinfecting wet wipes, lens cleaner wipes, and cotton or cleaning swabs found in the consumer retail market. However, beyond just this physical similarity, an indicator wipe is not a cleaning or disinfecting wipe at all, but rather it is a tool used to make a qualitative chemical assessment of what might be on a surface.

An indicator wipe may be of any shape, such as square, rectangular, or circular. The shape and size are selected such that the indicator wipe can be conveniently bunched up to wipe around a surface, and large enough to provide space for an ensuing chromatography to be visible. In various embodiments, indicator wipes may be individually packaged in single unit packages, or they can be provided in the form of a perforated roll where each individual indicator wipe is torn off from the roll and used as needed. Such a roll can be packaged in a cylindrical dispensing canister. A square shaped indicator wipe in accordance with the present disclosure may measure measuring about 1 inch (2.5 cm)×1 inches (2.5 cm) up to about 6 inches (15.25 cm)×6 inches (15.25 cm). For example, in various embodiments, an indicator wipe substrate may measure about 2 inches (5 cm)×2 inches (5 cm), or 3 inches (7.6 cm)×3 inches (7.6 cm). A circular substrate for forming an indicator wipe may measure about 2 inches (5 cm) in diameter up to about 6 inches (15.25 cm) in diameter. These relative dimensions are understood to apply to substrates that may be some other shape rather than square or circular. A circular indicator wipe at least has the advantage of being easier to bunch up such that only a central region is exposed for wiping on a surface. However, square, or rectangular shaped indicator wipes ensure that substrate salvage is not created, or salvage is at least minimized, when individual wipes or long, perforated strips of substrate material for rolls are cut out of bulk substrate material.

In various embodiments, the substrate may be attached to an end of a dowel or stick to form a swab. In various embodiments, the substrate may be shaped to form a nib which is attached to the body of marker style, pen style or other handheld barrel shaped instrument body analogous to the shape of generally available marker, pen or other handheld instruments. In these various embodiments, the user can avoid inadvertently coloring the skin with the various dye compositions by grasping the dowel or instrument body portion. Packaging is configured to keep the indicator substrate from drying out before use, and/or from being oxidized by air, and can include plastics or foil laminated paper materials, such as plastic caps or heat-sealed pouches, as a barrier to evaporation and oxygen. Packaging can be optimized to ensure a reasonable shelf-life for the indicator substrate.

As used herein, the terms “wetted” and “impregnated” interchangeably refer to a condition of a substrate having been treated with an aqueous solution. Impregnated is perhaps a more accurate term to describe the wetting of a substrate since liquid added to a nonwoven or woven substrate tends to absorb into the interstices between the fibers and visibly disappear. The wetting/impregnating may be reported in grams (or mL's) of aqueous dye composition per square inch of substrate or per piece/swatch of substrate of a certain size. For example, an indicator wipe may comprise a 2 inch (5 cm)×2 inch (5 cm) piece of nonwoven polyester wetted/impregnated with 1 gram of aqueous dye composition. In various embodiments, an indicator wipe may comprise a substrate impregnated at a level of 1 gram liquid/4 in²=0.25 g/in². In various embodiments, an indicator wipe may comprise a substrate impregnated at a level of 1 gram liquid/9 in²=0.11 g/in². In various embodiments, an indicator wipe may comprise a substrate impregnated at a level of from about 0.1 g/in² to about 0.5 g/in². Whether or not the particular substrate, cut to a certain size, is fully saturated or just partially wetted by a certain amount of liquid is not relevant. Unlike a cleaning wipe, an indicator wipe does not need to express a certain amount of liquid onto a surface, but instead needs to be just wet enough to liberate dry residues from a surface and to pick up those chemical residues into the substrate where they can chemically interact with the aqueous dye composition present in the wipe.

As used herein, the term “surface” refers to a portion of an object capable of treatment with a cleaner, a disinfectant, or any other type of chemical, such as being coating with a residual antimicrobial composition or washed and sanitized with a quaternary ammonium disinfectant. The surface may comprise an exposed portion, such as one side for example, of an object that is subjected to cleaning, contact sanitizing/disinfecting and/or coating. A surface herein may comprise a “hard surface” or a “soft surface.” The terms hard and soft, when used in conjunction with the term surface, are well known terms of art. A hard surface may comprise a nonporous or a porous material. Likewise, a soft surface may comprise a nonporous or a porous material. An example of a hard, nonporous surface herein, which may be subjected to a detection of chemical residues, is a steel surface or a glass surface. An example of a hard, porous surface is unfired pottery, or raw-ware, for example. An example of a soft, nonporous surface herein, which may be subjected to a detection of chemical residues, is a vinyl surface, such as a seat cushion upholstered with Naugahyde® or other brand of vinyl fabric. A soft, porous surface, may be a canvas gurney or stretcher, for example. These examples are not meant to be limiting, but instead are presented in order to demonstrate the breadth of surfaces that may comprise chemical residues of interest to be detected by the systems, indicator wipe product, and methods of the present disclosure.

As used herein, reference to various colors, such as for example, “blue,” “purple,” or “blue-violet,” refer to those colors in the visible spectrum frequently described as ROYGBV (red, orange, yellow, green, blue, and violet) and that relate to particular ranges of the visible electromagnetic spectrum. Colors that develop and migrate on an indicator wipe are described qualitatively, seeing that for the methods to be convenient, particularly when used in the field, the user would not necessarily have a color analyzer at hand. The qualitative conclusion that a spot or halo migrating out on an indicator wipe is visibly observed to be of a particular color means that what is seen by the human eye is a color that fits a particular known range of the visible light spectrum. The following are the colors of visible light: red: 620-750 nm; orange: 590-620 nm; yellow: 570-590 nm; green: 495-570 nm; blue: 450-495 nm; and violet: 380-450 nm. So, for example, if a spot on an indicator wipe is seen to develop a “blue color” after having been wiped on a surface to pick up residue, one knows that the observed color on the indicator wipe, if it were measured in a color analyzer suitable for textiles, would have a wavelength from about 450 to about 495 nm.

### General Embodiments

Indicator Wipe Substrates:

An indicator wipe in accordance with the present disclosure is an article of manufacture comprising a woven, nonwoven, or double-knit fabric substrate at least partially wetted with an aqueous dye solution. In various embodiments, a product provided as part of a cationic polymer detection system may comprise an indicator wipe operable to visualize various cationic-dye complexes.

In various embodiments, a substrate for an indicator wipe may comprise a woven, nonwoven, or double-knit fabric swatch comprising at least some synthetic material such as polyester such that the substrate is capable of functioning as a chromatographic media for aqueous mixtures.

In various embodiments, the substrate for an indicator wipe may comprise a woven, nonwoven, or double-knit fabric swatch measuring about 1 inch (2.5 cm)×1 inches (2.5 cm) up to about 6 inches (15.25 cm)×6 inches (1525 cm). For example, in various embodiments, an indicator wipe substrate may measure about 2 inches (5 cm)×2 inches (5 cm), or 3 inches (7.6 cm)×3 inches (7.6 cm). A circular substrate for forming an indicator wipe may measure about 2 inches (5 cm) in diameter up to about 6 inches (15.25 cm) in diameter. These relative dimensions are understood to apply to substrates that may be rectangular or some other shape.

In various embodiments, a substrate for an indicator wipe may comprise nonwoven polyester gauze sponge, such as Dynarex® 3252 nonwoven sponge, 4-ply, polyester blend, available from The Dynarex Corporation, Orangeburg, N.Y. This material is described as being made of parallel laid, cross laid, or randomly laid webs bonded with application of adhesive or thermoplastic fibers under application of heat and pressure. In various embodiments, this substrate is used “as is,” meaning it is left as 4-ply.

In various embodiments, a substrate for an indicator wipe may comprise double-knit polyester, such as CleanMo® #WIP-1009D-LE-140G, available from Shenzhen CleanMo Technology Co., Ltd., China. This material is described as being made from knitted filament polyester, with a finished basis weight of 120 g/m² and an absorbency of 412 mL/m². Each of these cleanroom wipes measure 9 inches (23 cm)×9 inches (23 cm). Therefore, each wipe can be cut, for example, into nine (9) separate 3 inch (7.6 cm)×3 inch (7.6 cm) substrate swatches for wetting into indicator wipes.

The substrate materials that do not suffice as substrate for an indicator wipe include, but are not limited to, WYPALL® wiper sheets (double reinforced crepe material, generally cellulose enhanced and made of recycled materials); NEW PIG® paper toweling; and 50% polyester/50% cotton woven cloth. In general, most cellulose-based substrates were found unsuitable for indicator wipes.

Indicator Swab Substrates:

An indicator swab in accordance with the present disclosure is an article of manufacture comprising a woven, nonwoven, double-knit fabric, cotton, functionalized cellulose, or open cell foam material at least partially wetted with an aqueous dye solution attached to a stick to form a swab. The stick may be formed from wood, plastic or other materials of desired strength and chemical composition suitable for indicator swabs.

In various embodiments, a product provided as part of a cationic polymer detection system may comprise an indicator swab operable to visualize various cationic-dye complexes.

Sulfonephthalein and Azo Dyes:

In various embodiments, an indicator wipe in accordance with the present disclosure may comprise a substrate at least partially wetted with an aqueous dye composition. In various embodiments, an aqueous dye composition is operable to undergo a chemical reaction or chemical reactions involving acid/base dye chemistry and/or ionic complexation between certain dye molecules and cationic species such as quaternary ammonium compounds, (i.e., having a generalized structure (dye−)(quat+) or (dye−)(cationic polymer+))

In various embodiments, an aqueous dye composition for use in an indicator wipe in accordance with the present disclosure may comprise at least one sulfonephthalein dye. These types of dyes are generally made by condensing phenols with anhydrides or acid chlorides of o-sulfobenzoic acid or its derivatives. Sulfonephthalein dyes are sensitive to pH, and their color change is caused by deprotonated versus protonated forms based on solution pH. The color of sulfonephthalein dyes are further changed if the dye is complexed with a quaternary compound. The association between a sulfonephthalein dye and an ordinary monomeric quaternary ammonium compound or a cationic polymer is generally inefficient unless the sulfonephthalein dye is in its deprotonated state. This is likely because the complex is ionic in nature, wherein a negatively charged, deprotonated sulfonephthalein dye ionically associates with a positively charged cationic polymer species or a monomeric quaternary ammonium species.

Although there is no apparent color difference between a complex formed from a sulfonephthalein dye and an ordinary monomeric non-silane quaternary versus a complex formed from a sulfonephthalein dye and a cationic polymer such as a quaternary silane in a polymeric form, the migration or diffusion rates for these two types of ionic complexes on a substrate are significantly different. As described herein, this difference in migration rates, visible as the complexes undergo chromatography on the wetted substrate, is what allows the user to distinguish traditional non-silane, monomeric quaternary ammonium compound residues from quaternary silane or other cationic polymer antimicrobial coating residues. Generally speaking, a complex between a sulfonephthalein dye and an ordinary non-silane quaternary compound migrates more readily and much faster on a chromatographically capable substrate than a complex between a sulfonephthalein dye and a cationic polymer such as a quaternary silane compound in polymeric form. This difference is probably due to the quaternary silane compounds being polymeric by virtue of the reactive silicon forming O—Si—O bonds, whereas ordinary non-silane quaternary ammonium compounds are monomeric and incapable of polymerizing. So, although both cationic species are capable of forming an anionic complex with a negatively charged dye molecule, the complex from the cationic polymer species has no detectable chromatographic migration whereas the complex from the monomeric quaternary compound readily migrates.

In various embodiments, an aqueous dye composition for use in an indicator wipe in accordance with the present disclosure may comprise at least one sulfonephthalein dye selected from the group consisting of bromophenol blue (BPB), bromocresol purple (BCP), bromocresol green (BCG), bromothymol blue (BTB), cresol red (CR), chlorophenol red (CB), m-cresol purple (CP), thymol blue (TB), and alizarin red S (ARS). Although not a sulfonephthalein dye, but instead a xanthene dye, erythrosine B (EB) dye (i.e., FD&C Red No. 3) was screened for use herein; however this dye was found to not be useful in differentiating between traditional non-silane quat residues and residual antimicrobial coatings comprising a quaternary silane.

In various embodiments, an aqueous dye composition for use in an indicator wipe may comprise at least one sulfonephthalein dye at a total amount of from about 1 ppm to about 500 ppm, or from about 0.0001 wt. % to about 0.0500 wt. %, based on the total weight of the aqueous composition. In various embodiments, an aqueous dye composition for use in an indicator wipe may comprise at least one sulfonephthalein dye at a total amount of from about 1 ppm to about 100 ppm, or from about 0.0001 wt. % to about 0.0100 wt. %, based on the total weight of the aqueous composition. In various embodiments, an aqueous dye composition for use in an indicator wipe may comprise at least one sulfonephthalein dye at a total amount of from about 5 ppm to about 30 ppm, or from about 0.0005 wt. % to about 0.0030 wt. %, based on the total weight of the aqueous composition. A single dye system refers to an aqueous dye composition for use in an indicator wipe comprising a sulfonephthalein dye at from about 1 ppm to about 500 ppm, or from about 0.0001 wt. % to about 0.0500 wt. %, based on the total weight of the aqueous composition, and no other dye type such as an azo dye.

In various embodiments, an aqueous dye composition for use in an indicator wipe may comprise a sulfonephthalein dye at from about 20 ppm to about 30 ppm, or from about 0.0020 wt. % to about 0.0030 wt. %, based on the total weight of the aqueous composition.

In various embodiments, an aqueous dye composition for use in an indicator wipe may comprise a sulfonephthalein dye at about 25 ppm or about 0.0025 wt. %, based on the total weight of the aqueous composition.

In various embodiments, an aqueous dye composition for use in an indicator wipe in accordance with the present disclosure may comprise at least one sulfonephthalein dye and at least one azo dye. These systems are referred to as two-dye systems (meaning two types of dyes in a composition).

Azo dyes for use herein are characterized as azosulfonates, azocarboxylates, or bisazosulfonates. Azo dyes for use herein, and for use in conjunction with the at least one sulfonephthalein dye, are generally pH indicator dyes.

In various embodiments, an aqueous dye composition for use in an indicator wipe in accordance with the present disclosure may comprise at least one sulfonephthalein dye, and also at least one sulfonated or carboxylated azo dye selected from the group consisting of alizarin yellow R (AYR), methyl red (MR), methyl orange (MO), metanil yellow (MY), benzopurpurin 4B (B4B), β-naphthol violet (NV), orange II (OII), congo red (CG), and yellow 2G (Y2G).

In various embodiments, an aqueous dye composition for use in an indicator wipe may comprise at least one azo dye at a total amount of from about 1 ppm to about 500 ppm, or from about 0.0001 wt. % to about 0.0500 wt. %, based on the total weight of the aqueous composition. In various embodiments, an aqueous dye composition for use in an indicator wipe may comprise at least one azo dye at a total amount of from about 1 ppm to about 100 ppm, or from about 0.0001 wt. % to about 0.0100 wt. %, based on the total weight of the aqueous composition. In various embodiments, an aqueous dye composition for use in an indicator wipe may comprise at least one azo dye at a total amount of from about 5 ppm to about 30 ppm, or from about 0.0005 wt. % to about 0.0030 wt. %, based on the total weight of the aqueous composition.

In various embodiments, a two-dye system aqueous dye composition for use in an indicator wipe may comprise a sulfonephthalein dye at from about 1 ppm to about 500 ppm, or from about 0.0001 wt. % to about 0.0500 wt. %, and an azosulfonate, azocarboxylate, or bisazosulfonate dye at from about 1 ppm to about 500 ppm, or from about 0.0001 wt. % to about 0.0500 wt. %, based on the total weight of the aqueous composition. In various embodiments, a two-dye system aqueous dye composition for use in an indicator wipe may comprise a sulfonephthalein dye at from about 1 ppm to about 100 ppm, or from about 0.0001 wt. % to about 0.0100 wt. %, and an azosulfonate, azocarboxylate, or bisazosulfonate dye at from about 1 ppm to about 100 ppm, or from about 0.0001 wt. % to about 0.0100 wt. %, based on the total weight of the aqueous composition. In various embodiments, a two-dye system aqueous dye composition for use in an indicator wipe may comprise a sulfonephthalein dye at from about 1 ppm to about 30 ppm, or from about 0.0001 wt. % to about 0.0030 wt. %, and an azosulfonate, azocarboxylate, or bisazosulfonate dye at from about 1 ppm to about 30 ppm, or from about 0.0001 wt. % to about 0.0030 wt. % based on the total weight of the aqueous composition. In various embodiments, a two-dye system aqueous dye composition for use in an indicator wipe may comprise a sulfonephthalein dye at from about 20 ppm to about 30 ppm, or from about 0.0020 wt. % to about 0.0030 wt. %, and an azosulfonate, azocarboxylate, or bisazosulfonate dye at from about 10 ppm to about 20 ppm, or from about 0.0010 wt. % to about 0.0020 wt. % based on the total weight of the aqueous composition.

Antimicrobials to Prevent Microbial Growth in the Aqueous Environment:

In various embodiments, an aqueous dye composition for use in an indicator wipe in accordance with the present disclosure may comprise a non-quaternary antimicrobial for the purpose of reducing microbial growth in the composition and/or on the indicator wipe comprising the aqueous composition. In various embodiments, the antimicrobial may comprise a lower molecular weight alcohol such as ethanol or isopropanol.

In various embodiments, an aqueous dye composition for use in an indicator wipe in accordance with the present disclosure may comprise from 2 wt. % to about 10 wt. % ethanol or isopropanol, based on the total weight of the aqueous dye composition to prevent microbial growth.

In various embodiments, an aqueous dye composition for use in an indicator wipe in accordance with the present disclosure is acidic by nature of the one or more dyes present. In various embodiments, an aqueous dye composition for use in an indicator wipe is pH adjusted to be acidic, that is, adjusted to a pH of less than 7 with various acids or buffers. In various embodiments, an aqueous dye composition for use in an indicator wipe has a pH of from about 1 to about 4. In various embodiments, the aqueous dye composition has a pH of about 1 to about 3, or a pH of about 2. In various embodiments, pH of the aqueous dye composition is adjusted by the addition of at least one of an acid, an alkali, or a buffer.

pH Adjusters and pH Buffers:

In various embodiments, aqueous dye compositions may further comprise one or more acidifying agents or alkaline agents as necessary to neutralize various ingredients, shift an equilibrium of a particular dye between open and cyclic forms, produce salts of various ingredients, and/or achieve a particular pH target for the composition, such as an acidic pH.

In various embodiments, the compositions are acidic, having a pH of less than about 7. In various embodiments, the pH of the composition is from about 1 to about 6. In various embodiments, the pH of the composition is from about 1.5 to about 2.5. In various embodiments, the pH of the composition is about 2.

Combinations of various acidifying agents and alkaline agents may be used to create buffering systems to stabilize a desired pH of the composition. Buffers may be mixed buffers, meaning that the alkaline agent need not necessarily be the conjugate base of the acidifying agent.

Exemplary acidifying agents for use in the present aqueous dye compositions include, but are not limited to, organic acids of any molecular weight and mineral acids (inorganic acids), and mixtures thereof. Organic acids may include mono-carboxylic acids, di-carboxylic acids, or tri-carboxylic acids, and may be saturated or may have any degree of unsaturation. For example, organic acids for use in various embodiments of the composition in accordance to the present disclosure may include, but are not limited to, formic acid, carbonic acid, acetic acid, lactic acid, oxalic acid, propionic acid, valeric acid, enanthic acid, pelargonic acid, butyric acid, lauric acid, docosahexaenoic acid, eicosapentaenoic acid, pyruvic acid, acetoacetic acid, benzoic acid, salicylic acid, aldaric acid, fumaric acid, glutaconic acid, traumatic acid, muconic acid, malonic acid, malic acid, succinic acid, glutaric acid, adipic acid, pimelic acid, suberic acid, azelaic acid, abietic acid, pimaric acid, sebacic acid, phthalic acid, isophthalic acid, terephthalic acid, maleic acid, citric acid, and combinations thereof.

Exemplary acidifying agents for use in the present aqueous dye compositions include, but are not limited to, mineral acids. Mineral acids for use in various embodiments of the composition in accordance to the present disclosure may include, but are not limited to hydrochloric acid, phosphoric acid, sulfuric acid, nitric acid, and combinations thereof.

Exemplary alkaline materials include any organic amines, NH₃, alkali metal or alkaline earth hydroxide, any conjugate bases of any organic acids (e.g., R—COO⁻), and any of the salts of carbonic acid, phosphoric acid, nitric acid and sulfuric acid, and any mixtures thereof. For example, alkaline materials for use in various embodiments of the composition in accordance to the present disclosure may include, but are not limited to, NaOH, KOH, NH₃, sodium acetate, sodium succinate, disodium succinate, monosodium citrate, disodium citrate, trisodium citrate, NaH₂PO₄, Na₂HPO₄, Na₃PO₄, KH₂PO₄, K₂HPO₄, K₃PO₄, NaHSO₄, Na₂SO₄, KHSO₄, K₂SO₄, NaHCO₃, Na₂CO₃, KHCO₃, K₂CO₃, NaH₃P₂O₇, Na₂H₂P₂O₇, Na₃HP₂O₇, Na₄P₂O₇, KH₃P₂O₇, K₂H₂P₂O₇, K₃HP₂O₇, K₄P₂O₇, and mixtures thereof. Any of these chemical species may exist as various hydrates when purchased as raw materials for use in the present aqueous dye compositions.

TABLE 1 sets forth various aqueous dye compositions that find use in indicator wipes in accordance with the present disclosure. As described in more detail herein, each of these and related aqueous dye compositions may be applied to a substrate swatch to produce an indicator wipe. In TABLE 1, compositions 1, 2, and 3 are single dye systems (sulfonephthalein dye), whereas compositions 4, 5, and 6 are two-dye systems (sulfonephthalein and azo dyes).

TABLE 1
Aqueous Dye Compositions for use in Indicator Wipes

| | | Aqueous Dye Compositions (wt. %) | | | | | |
|---|---|---|---|---|---|---|---|
| Ingredients | Description | 1 | 2 | 3 | 4 | 5 | 6 |
| Bromocresol purple | Sulfonephthalein | 0.0025 | 0 | 0 | 0.0015 | 0.0015 | 0 |
| Bromothymol blue | Sulfonephthalein | 0 | 0.0025 | 0 | 0 | 0 | 0 |
| Chlorophenol red | Sulfonephthalein | 0 | 0 | 0.0025 | 0 | 0 | 0 |
| Cresol red | Sulfonephthalein | 0 | 0 | 0 | 0 | 0 | 0.0015 |
| Methyl red | Azo | 0 | 0 | 0 | 0.0010 | 0 | 0 |
| Orange II | Azo | 0 | 0 | 0 | 0 | 0.0010 | 0 |
| Metanil yellow | Azo | 0 | 0 | 0 | 0 | 0 | 0.0010 |
| HCl | Acidic agent | 11 | 11 | 11 | 11 | 11 | 11 |
| | Alkaline agent | 0 | 0 | 0 | 0 | 0 | 0 |
| Ethanol/2-propanol | Antimicrobial | 4 | 4 | 4 | 4 | 4 | 4 |
| Water | Aqueous diluent | 84.9975 | 84.9975 | 84.9975 | 84.9975 | 84.9975 | 84.9975 |
| | Total | 100.00% | 100.00% | 100.00% | 100.00% | 100.00% | 100.00% |
| Physical Properties | Appearance | yellow | yellow | yellow | yellow | orange | yellow |
| | Absorbance | 431 nm | 432 nm | 434 nm | 434 nm | 468 nm | 434 nm |
| | pH | 2 | 2 | 2 | 2 | 2 | 2 |

In various embodiments, any one of the aqueous compositions in TABLE 1, or suitable variations thereof based on the general descriptions provided herein, are used in combination with a substrate swatch to make an indicator wipe. An indicator wipe may comprise a substrate at least partially wetted with an aqueous dye composition such as one of the compositions set forth in TABLE 1.

Indicator Wipes:

TABLE 2 sets forth various indicator wipes based on a combination of the aqueous dye compositions of TABLE 1 and preferred substrates. For the indicator wipes that comprise nonwoven polyester, this substrate was 4-ply material as purchased and described above, and was left as 4-ply. Each nonwoven polyester indicator wipe measured 2 inches (5 cm)×2 inches (5 cm) (or 4 in² swatches). For the double-knit filament polyester indicator wipes, the size of each indicator wipe was 3 inches (7.6 cm)×3 inches (7.6 cm) (or 9 in² swatches).

TABLE 2
Indicator Wipes

| | Indicator Wipes | | | | | |
|---|---|---|---|---|---|---|
| Description | A | B | C | D | E | F |
| Composition used | 1 | 2 | 3 | 4 | 5 | 6 |
| (from Table 1) | | | | | | |
| Substrate used | Nonwoven | Nonwoven | Double-knit | Double-knit | Double-knit | Double-knit |
| | polyester | polyester | polyester | polyester | polyester | polyester |
| Wetting (grams | 1 g/each 4 in² | 1 g/each 4 in² | 1 g/each 9 in² | 1 g/each 9 in² | 1 g/each 9 in² | 1 g/each 9 in² |
| liquid/wipe) | substrate | substrate | substrate | substrate | substrate | substrate |
| Wipe appearance | yellow | yellow | yellow | yellow | orange | yellow |
| Absorbance | 431 nm | 432 nm | 434 nm | 434 nm | 468 nm | 434 nm |

Use of Indicator Wipes to Detect Cationic Polymers and to Distinguish Non-Silane Monomeric Quaternary Residues from Cationic Polymer Residues on a Surface:

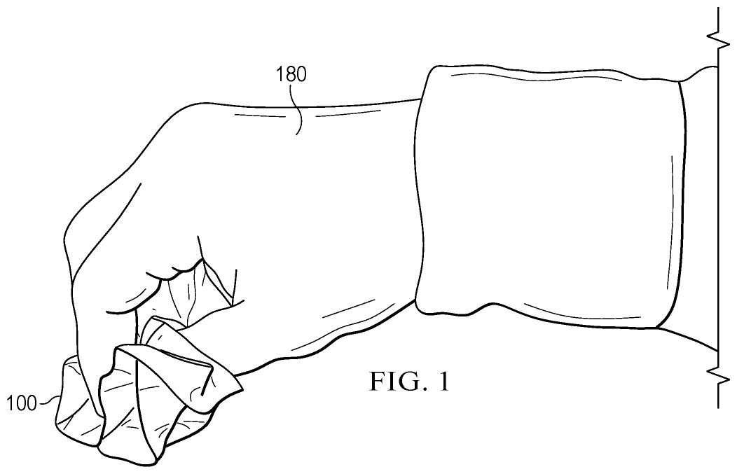

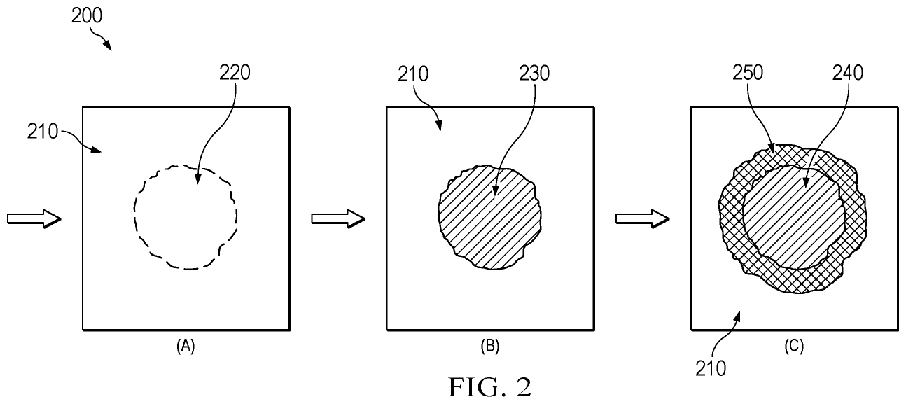

A general method for detecting a cationic polymer such as a quaternary silane residue on a surface, and for differentiating between non-silane monomeric quaternary compound (quat) residue and cationic polymer residue, is exemplified in FIGS. 1 and 2.

As mentioned, a cationic polymer residue, such as a polyhexanide or polymerized quaternary silane residue may be present on a surface from the purposeful coating of the surface with a residual antimicrobial coating composition comprising a cationic polymer. In various embodiments, a coating to be detected on a surface may have been previously formed from an aqueous composition comprising dimethyloctadecyl[3-(trihydroxysilyl)propyl]ammonium chloride, 3-chloropropyltrimethoxysilane, and triethanolamine, or from a composition comprising dimethyloctadecyl[3-(trihydroxysilyl)propyl]ammonium chloride, 3-chloropropyltrimethoxysilane, 3-aminopropyltriethoxysilane, and triethanolamine.

On the other hand, a non-silane monomeric quaternary compound residue on a surface might simply be the result of the surface having been cleaned/disinfected at some time by a non-silane, ordinary quat and then that surface either poorly rinsed or not rinsed at all. Detecting cationic polymer, e.g., quaternary silane residue, is important at least for the sake of verifying that a surface still has a residual antimicrobial coating, such as to mitigate pathogen transfer on the surface. A negative detection result may indicate that a cationic polymer residual antimicrobial coating was present but has since worn off the surface, or that the surface was improperly coated with the residual antimicrobial coating, or perhaps that the surface was not coated at all with a cationic polymer composition.

FIG. 1 illustrates use of an indicator wipe to wipe a surface that may have silane or non-silane quaternary residues. The method begins with an indicator wipe 100 bunched up in the user's hand 180 for wiping across or around a small area of the surface to be tested. As mentioned, the indicator wipe 100 is preferably bunched up such that only a central region of the wipe is exposed and ultimately wiped on the surface, that way the ensuing chromatography can be observed as halos radiating outward on the wipe. In various embodiments, wrapping the indicator wipe on the end of a stick, dowel or other suitably shaped tool eliminates the need for scrunching up the indicator wipe in the user's hand. To avoid inadvertently coloring the skin with the various dye compositions, suitable chemically resistant gloves can be worn by the user holding the indicator wipe. Not illustrated in the figures are optional prior steps wherein the user obtains the indicator wipe from some type of packaging, such as by tearing open a single use package or pulling a single indicator wipe from a dispensing roll and tearing it across a perforation to separate it from the roll of wipes. Packaging is configured to keep the indicator wipe from drying out before use, and/or from being oxidized by air, and can include plastics or foil laminated paper materials, such as heat-sealed pouches, as a barrier to evaporation and oxygen. Packaging can be optimized to ensure a reasonable shelf-life for the indicator wipe.

For the wiping process, an area of the surface to be tested can be expanded out if no color changes are observed on the indicator wipe. For example, an indicator wipe (e.g., 4 in² or 9 in², scrunched up such that only a central region is exposed) can be wiped around an area of surface measuring about 2 inches×2 inches. The test area can then be expanded if nothing is detected, e.g., to 2″×4″, to 2″×6″, or to 4″×4″ wipe areas.

As an example, cationic polymer coatings wherein the polymer is a quaternary silane coating that exhibits residual antimicrobial efficacy, may typically be present from about 0.01 to about 0.03 mg/in² of dried composition. Based on this expected level of residual antimicrobial coating, if a 4″×4″ area of the surface is wiped with an indicator wipe and there is a visible color change on the wipe, then the residual antimicrobial coating level on the surface would be no less than about 0.02 mg/in². On the other hand, if a 4″×4″ area of surface is wiped with an indicator wipe and there is no color change at all, then one can conclude there is no detectable residual antimicrobial coating on the surface that would comprise a cationic polymer such as a polymerized quaternary silane.

FIG. 2 sets forth the sequence of events that take place on the indicator wipe 200 after it has been wiped around a portion of a surface to be tested.

In panel (A) of FIG. 1, the indicator wipe 200 from FIG. 1 will, in certain situations, have a central region 220 on the substrate 210 where chemical residues reside. Immediately after wiping (FIG. 1), the wipe 200 in FIG. 2(A) may not have any color developing in central region 220 as the dye indicator chemistry is yet to take place. The zone 220 may or may not be visible initially, since the wipe 200 began in a wetted state, and several moments are required for dye chemistry to ensue.

As illustrated in FIG. 2 panels (B) and (C), two separate and sequential events take place on the indicator wipe 200. First, the central region 220 where the chemical residues were picked up undergoes a particular color change to central region 230. Then, chromatography ensues wherein the mixture of dye complexes migrate radially outward from the central region 230 to produce a halo 250 shown in panel (C). In various embodiments, the transition from (B) to (C) also includes additional color changes to the central region 240 as the various substances wick out to form the halo 250. The initial color change (220 to 230) in the central region, the chromatography (when visible as a halo that forms) and the color of the halo 250 (if any), and further color changes (230 to 240) within the central region, if any, each inform the user whether the residue on the surface being tested comprise cationic polymer, traditional non-silane monomeric quaternary ammonium compound, or perhaps neither. The ability of the methods to detect cationic polymer residues such as polymerized quaternary silane residues and to distinguish between quaternary silane and traditional non-silane quaternary residues are demonstrated by the working examples below. In various embodiments, the apparatus and methods describing the use of an indicator wipe may be applied and adapted for use with swabs and other substrates described herein.

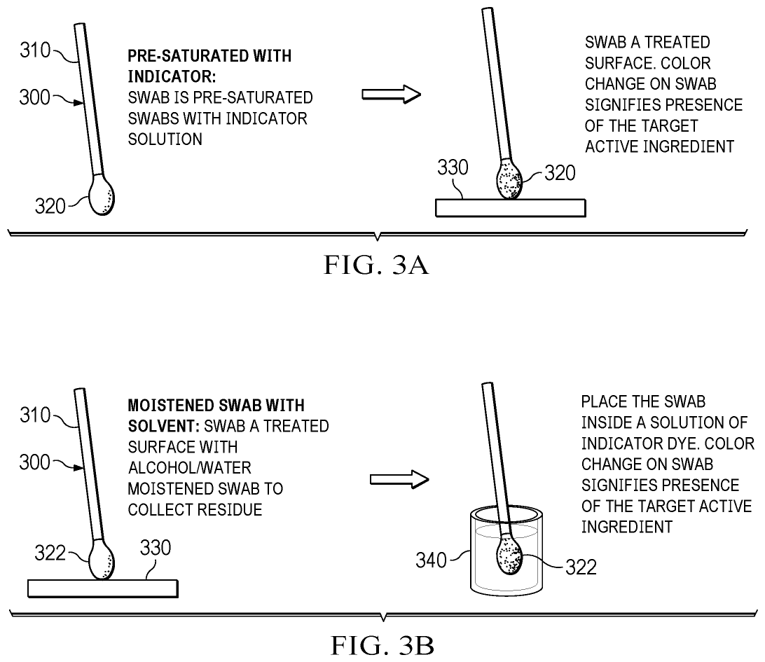

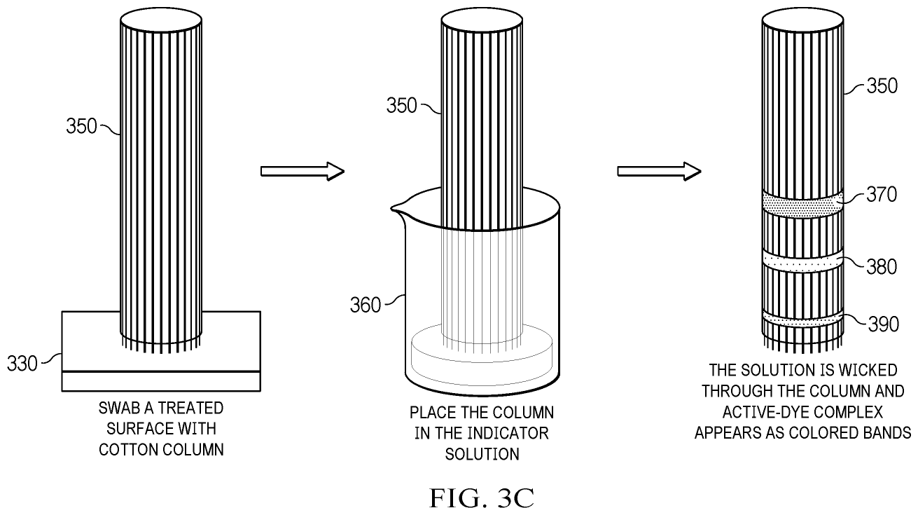

FIGS. 3A-3C illustrate use of an indicator wipe to wipe a surface that may have silane or non-silane quaternary residues. Turning to FIG. 3A, an indicator wipe in the form of a swab 300 comprising a stick 310 with swab tip 320 is pre-saturated with an indicator solution. The swab tip 320 is wiped along a portion of the surface 330 to be tested for the presence of the target active ingredient. The swab tip 320 is then monitored for color change which signifies the presence of the target active ingredient. FIG. 3B illustrates an indicator wipe in the form of a swab 300 comprising stick 310 and swab tip 322 that is pre-moistened with a solvent, such as an alcohol or water. Swab tip 322 is wiped along a portion of the surface 330 to be tested for the presence of the target active ingredient. The swab tip 322 is then placed into a vial or container of indicator solution dye 340. In various embodiments, the swab tip 320 is then monitored for color change which signifies the presence of the target active ingredient. In various embodiments, the indicator solution dye 340 in the vial or container containing the indicator solution dye 340 is monitored for color change which signifies the presence of the target active ingredient. In various embodiments, the color change of the swab tip 320 or indicator solution dye 340 is monitored by visual or spectroscopic equipment and methods as is known in the art.

FIG. 3C illustrates an indicator wipe in the form of cellulose/cotton fibers packed into a columnar form 350. The packed fiber column 350 is then wiped along a portion of the surface 330 to be tested for the presence of the target active ingredient. Next, the packed fiber column 350 is then placed into a vial or container of indicator solution 360. The indicator solution wicks through the fibers in the packed fiber column 350 and active-dye complexes appear as colored bands 370,380,390 on the packed fiber column 350 indicating the presence of the target active ingredient.

### EXAMPLES

In these examples, three commercially available disinfectant products having ordinary non-silane quaternary ammonium compounds were used, along with two commercial residual antimicrobial coating products comprising quaternary silane compounds as the cationic polymers. It is to be understood that although this group of examples demonstrates the ability for the systems herein to detect quaternary silanes, and to distinguish quaternary silanes from non-silane monomeric quaternary ammonium compounds, the disclosure is not so limited. The systems, indicator wipe, and methods thereof are capable of detecting cationic polymers in general and to distinguish cationic polymers from monomeric cationic compounds.

The non-silane quaternary disinfectant products included VIREX TB® (0.21 wt. % total quats, pH=12, from Diversey, referred to as “quat-1”), MICROBAN 24 HOUR® (0.8 wt. % total quats, 2.5 wt. % citric acid, pH=2, from the Proctor & Gamble Company, referred to as “quat-2”) and CALLA 1452 RTU® (2.713 wt. % total quats, pH=6.4, from Zip-Chem, referred to as “quat-3”). Each of these three commercial disinfectant products comprise ordinary non-silane quats and none of them comprise a quaternary silane. It is important to note that the residual antibacterial efficacy of the MICROBAN 24 HOUR® product is due to the presence of citric acid. This product does not contain a quaternary silane to achieve the residual antibacterial efficacy as claimed.

The quaternary silane products for testing included dimethyloctadecyl[3-(trimethoxysilyl)propyl]ammonium chloride solution (CAS No. 27668-52-6, 42 wt. % in methanol, from Sigma-Aldrich, herein “DMOD”), a residual antimicrobial coating composition comprising dimethyloctadecyl[3-(trihydroxysilyl)propyl]ammonium chloride, 3-chloropropyltrimethoxysilane, and triethanolamine, (herein referred to as “ABS-1”), and a residual antimicrobial coating composition comprising dimethyloctadecyl[3-(trihydroxysilyl)propyl]ammonium chloride, 3-chloropropyltrimethoxysilane, 3-aminopropyltriethoxysilane, and triethanolamine, (herein referred to as “ABS-2”).

Test surfaces were prepared by spraying each of the three commercial quat products quat-1, quat-2, or quat-3 through a trigger sprayer onto 304 stainless steel test surfaces and then allowing the wet surfaces to air dry. For the DMOD, ABS-1, and ABS-2, the liquid was electrostatically sprayed onto 304 stainless steel test surfaces and then allowing the wet surfaces to air dry.

A single-dye system indicator wipe denoted as indicator wipe C in TABLE 2, was used to wipe a 2″×2″ area of the treated stainless steel test surface, giving rise to various unique color changes and chromatographic events depending on the nature of the residue present on the test surface from quat-1, quat-2, quat-3, DMOD, ABS-1, or ABS-2 treatments. Recall indicator wipe C features a pH acidic aqueous dye composition.

The observations are summarized in TABLE 3 below, and are stated in reference to the FIG. 2 wipe element numbering in order to be precise. The indicator wipe C generally begins with a pale yellow color, and this pale yellow color remains at least in the regions of the indicator wipe outside the exposed central region (220/230/240) and beyond the periphery of any halo 250 that might form from wicking out from the central region. In other words, there are distant portions of the indicator wipe that are not involved in reactive dye chemistry or any chromatography since only the central region of the indicator wipe is contacted with the surface residues and the outer reaches of the wipe are too distant to participate in chromatography or chromatography did not take place due to the inability for certain polymeric quaternary silane-dye complexes to migrate.

In some instances, a central region and/or a halo on an indicator wipe during use may be observed as white colored (i.e., essentially colorless, appearing as a “clean spot” on an otherwise slightly yellow wipe), which is distinguishable from the faint yellow color of the indicator wipe prior to use. White regions may be the result of wicking of colored materials radially out into the wipe, with a concomitant fading of sorts, leaving behind what appear to be colorless areas, or may be due to various acid/base dye chemistries.

TABLE 3
Indicator wipe color changes observed for various quaternary residues

| Origin of the residue on the | Region of the Indicator Wipe 200 (see FIG. 2 for element numbering) | | | |
|---|---|---|---|---|
| stainless steel test surface | 220 | 230 | 240 | 250 |
| Quat-1 | Pale yellow | Blue to blue-violet | White to very faint | White to very |
| | | | blue | faint blue |
| Quat-2 | Pale yellow | White to pale | White to pale | White |
| | | yellow | yellow | |
| Quat-3 | Pale yellow | White to very faint | White to very faint | White |
| | | blue | blue | |
| DMOD | Pale yellow | Pale yellow to very | Pale yellow | n/a |
| | | faint blue | | |
| ABS-1 | Pale yellow | Pale yellow to very | Pale yellow | n/a |
| | | faint blue | | |
| ABS-2 | Pale yellow | Blue to blue-violet | Blue to blue-violet | n/a |

As shown in TABLE 3, dye complexes formed from non-silane quaternary ammonium compounds (quat-1, quat-2, or quat-3) and dye diffuse out quickly, usually in a couple of minutes, creating migratory halos that typically appear white as the initial blue to blue-purple color fades rather quickly. On the other hand, quaternary silane-dye complexes (DMOD, ABS-1, ABS-2) migrate extremely slowly, usually over hours, generally resulting in a centralized colored spot. Often, the indicator wipe will dry out in the air before any migration of a quaternary silane-dye complex could even occur. In other words, although the (dye−)(quat+) complexes might be blue or blue-violet colored regardless of the nature of the quaternary (non-silane quaternary or quaternary silane), the migratory rates are remarkably different. The (dye−)(quat+) complex, when the (quat+) is a traditional non-silane quaternary (and thus monomeric), migrates rapidly on the substrate, and in some embodiments, is accompanied by a concomitant fading of the blue to blue-violet color, whereas the (dye−)(quat+) complex, when the (quat+) is a quaternary silane (and thus polymeric), exhibits no appreciable migration, and thus the blue to blue-violet color of the remains concentrated in the central region of the indicator wipe with more of a visible color.

However, an additional observable effect, namely the intensity of the color of the (dye−)(quat+) complex, is caused by the extent to which the dye is deprotonated, recognizing that only partially deprotonated dye (the distribution of protonated/deprotonated forms) is dependent on pH of the indicator wipe and the presence of acidic or alkaline substances on the surface being wiped, and that less deprotonated dye will result in less (dye−)(quat+) complex and thus less color intensity.

For example, in addition to dimethyloctadecyl[3-(trimethoxysilyl)propyl]ammonium chloride, the ABS-2 surface residue may comprise the alkaline organosilane 3-aminopropyltriethoxysilane that renders the residual coating on the surface alkaline. The alkalinity provided by the residual 3-aminopropyltriethoxysilane is sufficient to overcome the acidity in the indicator wipe, resulting in a large concentrations of the deprotonated form of the sulfonephthalein dye and thus an intense blue to blue-violet color. In other words, pH effects determine how much (dye−)(quat+) complex is formed, and consequently, how intense the blue to blue-violet color will be.

In contrast, the ABS-1 surface residue (along with just DMOD residue) does not comprise the alkaline 3-aminopropyltriethoxysilane, and the small amount of triethanolamine in the ABS-1 coating composition prior to application on the surface has likely evaporated. In other words, the ABS-1 surface coating is not alkaline as compared to the ABS-2 surface residue. Hence, the central region 220 of the indicator wipe remains acidic (from the original aqueous dye composition), and there is no observed color change (or a very faint blue to blue-violet color) in the central region of the wipe and no migratory halo formation since the (dye−)(quat+) complex is polymeric.

Other indicator wipes in accordance with the present disclosure generally produce these same observations as per TABLE 3, except perhaps the actual colors observed may vary somewhat. For example, an indicator wipe featuring only bromocresol green will produce a vivid sky blue central spot for ABS-2 residues and no halos. For the quat-1, quat-2, and quat-3 residues, a bromocresol green indicator wipe will produce a very faint yellow central region with a very obvious white migratory halo. In this regard, the ordinary quat products will leave the indicator wipe looking as though there is a “white doughnut” shape on an otherwise very pale yellow substrate.

Similar results are seen with single-dye indicator wipes comprising bromothymol blue or bromocresol purple. The ABS-2 residue produces a blue or purple central region, respectively, whereas each of the quat-1, quat-2, and quat-3 residues produce a pale yellow colored wipe having a centrally located “white doughnut” shape. For either of these single-dye systems, the ABS-1 residue does almost nothing visible to the indicator wipe. That is, the indicator wipe generally remains a uniform pale yellow color after wiping a surface comprising the ABS-1 residue.

It should be noted that if one only desires a method for distinguishing between the ABS-1 and ABS-2 residues (the difference being the presence of 3-aminopropyltriethoxysilane in ABS-2 and its absence in ABS-1), the indicator wipe can be kept in the original pH of the beginning aqueous dye composition, (i.e., without addition of acid). Typically, the pH of these unadjusted systems without added acid are about 4 to about 5.

Detection Apparatus and Methods Using Differences in Chemical/Physical Properties

Surface pH—In various embodiments, the apparatus and methods described herein may be tailored to indicate or detect the presence of a preferred or target pH range by selecting indicators specific to the desired or target surface coating pH range and the addition of acid, base or buffer systems. Detecting differences in surface pH would be suitable when acidic active ingredients, such as citric acid, lactic acid, glycolic acid, peracetic acid, or active ingredients with high pH values, such as polyamines, are present on a surface. Differences in surface pH may indicate the presence of and type of acidic/basic residues from the cationic polymer formulation additives.

Examples of pH indicators which may be used with the apparatus and methods described herein to indicate or detect the presence of a preferred or target pH range specific to the desired or target surface coating pH range and the addition of acid, base or buffer system are described in Table 4 below.

TABLE 4
Common pH Indicators

| Indicator | pH Range | Acid | Base |
|---|---|---|---|
| 2,4-Dinitrophenol | 2.4-4.0 | colorless | yellow |
| Alizarin Red S | 4.0-5.6 | Red | yellow |
| Alizarin sodium sulfonate | 3.7-5.2 | yellow | violet |
| Alizarin yellow | 10.0-12.0 | yellow | lilac |
| Azolitmin | 5.0-8.0 | red | blue |
| Bromcresol green | 4.0-5.6 | yellow | blue |
| Bromcresol purple | 5.2-6.8 | yellow | purple |
| Bromocresol Green | 4.0-5.6 | yellow | blue |
| Bromocresol Purple | 5.2-6.6 | yellow | purple |
| Bromothymol Blue | 6.0-7.6 | yellow | Blue |
| Bromphenol blue | 6.2-7.6 | yellow | blue |
| Chlorphenol red | 5.4-6.8 | yellow | Red |
| Congo Red | 3.0-5.0 | Blue | Red |
| Cresol Purple | 1.2-2.8 | Red | yellow |
| Cresol Purple | 7.4-9.0 | yellow | purple |
| Cresol red | 7.2-8.8 | yellow | red |
| Cresolphthalein (meta) | 1.2-2.8 | Red | yellow |
| Cresolphthalein (meta) | 7.4-9.0 | yellow | purple |
| Cresolphthalein (ortho) | 8.2-9.8 | colorless | Violet |
| Diazo violet | 10.1-12.0 | yellow | violet |
| Dichlorofluorescein | 4.0-6.6 | colorless | green |
| Indigo Carmine | 11.6-14.0 | Blue | yellow |
| Methyl orange | 3.1-4.4 | red | orange |
| Methyl Orange - Xylene Cyanol | 2.9-4.6 | Purple | green |
| Methyl red | 4.4-6.2 | red | yellow |
| Methyl yellow | 2.9-4.0 | red | yellow |
| Naphtholphthalein (alpha) | 7.3-8.7 | Blue | green |
| Neutral red | 6.8-8.0 | red | yellow |
| Nile blue | 10.1-11.1 | blue | red |
| Nitramine | 11.0-13.0 | colorless | orange-brown |
| Pentamethoxy red | 1.2-2.3 | red-violet | colorless |
| p-Ethoxychrysoidine | 3.5-5.5 | red | yellow |
| Phenol red | 6.4-8.0 | yellow | red |
| Phenolphthalein | 8.0-10.0 | colorless | red |
| p-Nitrophenol | 5.0-7.0 | colorless | yellow |
| Poirrier's blue | 11.0-13.0 | blue | violet-pink |
| Rosolic acid | 6.8-8.0 | yellow | red |
| Salicyl yellow | 10.0-12.0 | yellow | orange-brown |
| Tetrabromphenol blue | 3.0-4.6 | yellow | blue |
| Thymol Blue | 1.2-2.8 | red | yellow |
| Thymolphthalein | 9.4-10.6 | colorless | blue |
| Trinitrobenzoic acid | 12.0-13.4 | colorless | orange-red |
| Tropeolin O | 11.0-13.0 | yellow | orange-brown |
| Tropeolin OO | 1.3-3.2 | red | yellow |
| Tropeolin OOO | 7.6-8.9 | yellow | rose-red |
| α-Naphtholbenzein | 9.0-11.0 | yellow | blue |
| α-Naphtholphthalein | 7.3-8.7 | rose | green |
| α-Naphthyl red | 3.7-5.0 | red | yellow |

Polarity—In various embodiments, the apparatus and methods described herein may be tailored to indicate or detect the presence of polar or nonpolar chemicals. Modification of the polarity of the indicator wipe affects the diffusion rate and color migration of the target ingredients and their complexes with the dye present on the indicator wipe. The difference in chemical interaction can be exploited to differentiate between polar and nonpolar chemicals, for example, the differentiation between polyquats and single quats present on a surface.

In various embodiments, modifying the polarity of the indicator wipe or substrate will affect the diffusion rate of the target ingredient dye complex. This distinct interaction can be exploited to differentiate between polar and non-polar chemicals. This approach is a qualitative technique, based on principles of liquid chromatography. The feasibility of fabric rolled stationary phase has been reported by Ladisch et al. (see Ladisch, M., & Zhang, L. (2016). Fiber-based monolithic columns for liquid chromatography. Analytical and Bioanalytical Chemistry, 408(25), 6871-6883), in which woven or contiguous fibers were used for rapid separations of various low molecular weight and macromolecules compatible with a range of mobile phase flow rates.

In various embodiments, the wipe surface can be considered the stationary phase and the dye solution acting as both mobile phase and indicator. The presence of hydroxy groups on cellulose wipes allows modification with silane coupling agents (see Abdelmouleh, M., Boufi, S., ben Salah, A., Belgacem, M. N., & Gandini, A. (2002). Interaction of Silane Coupling Agents with Cellulose. Langmuir, 18(8), 3203-3208; Gadhave, R. V., Dhawale, P. V., & Sorate, C. S. (2021). Surface Modification of Cellulose with Silanes for Adhesive Application: Review. Open Journal of Polymer Chemistry, 11(02), 11-30), or esterification (see Vieira, A. T., Assunção, R. M., & Faria, A. M. (2018). Stationary phase based on cellulose dodecanoate physically immobilized on silica particles for high-performance liquid chromatography. Journal of Chromatography A, 1572, 72-81), to tune the surface polarity. Depending on the structure of the linked modifier, different diffusion speed can be achieved, allowing for differentiation between polyquats and single quats.

For example, chloro silanes (SiR₃Cl, SiR₂Cl₂, SiRCl₃) or alkoxy silanes (SiR₃OR′, SiR₂(OR′)₂, SiR(OR′)₃) bearing a long chain alkyl group or ionic liquid moiety, where the former decrease the surface polarity and the latter increases the surface polarity (see Vidal, L., Riekkola, M. L., & Canals, A. (2012). Ionic liquid-modified materials for solid-phase extraction and separation: A review. Analytica Chimica Acta, 715, 19-41). Additional examples are described below:

Cellulose Functionalization with Silane Coupling Agents

| | Silane | Functionalized Cellulose |
|---|---|---|
| Polar silanes | 1-methyl-3-(3-(trialkoxysilyl)propyl)- 1H-imidazol-3-ium | 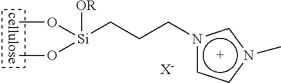 |
| | 4-methyl-3-(3-(trialkoxysilyl)propyl)- 1H-imidazol-3-ium | 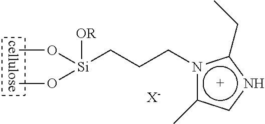 |
| | 3-(3-(trialkoxysilyl)propyl)- 1H-imidazol-3-ium | 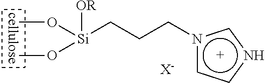 |
| | 1-propyl-3-(3-(trialkoxysilyl)propyl)- 1H-imidazol-3-ium | 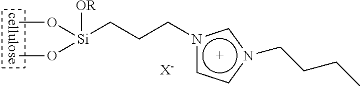 |
| | R = Me, Et, Pr, SiMe₃, (R′SiO_{3/2})n X⁻ = Cl⁻, Br⁻, I⁻, OTf⁻, OMs⁻, PF₆⁻, BF₄⁻ | |
| Non- polar silanes | Trialkoxyalkyl silane | 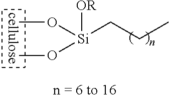 |
| | Dialkoxy dialkyl silane | 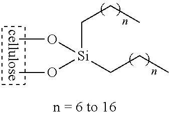 |
| | 4-(Trialkoxysilyl)butanenitrile | 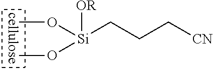 |

Cellulose Esterification

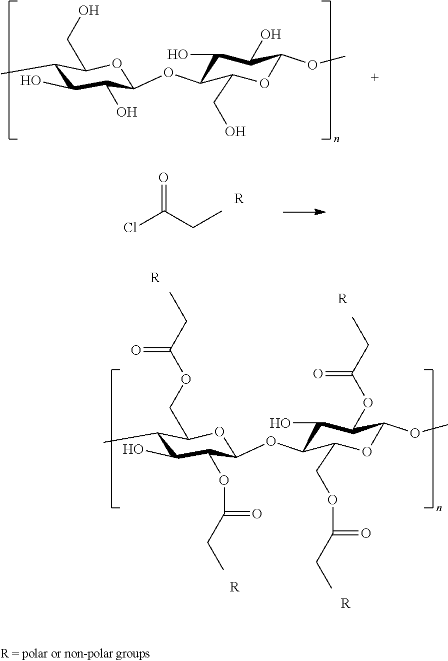

Charge—In various embodiments, the apparatus and methods described herein may be tailored to indicate or detect the difference in the electrical charge of the active chemical ingredient or ingredients. In various embodiments, anionic indicator substrates, such as sulfonephthalein dyes at basic pH, can be used to detect quaternary ammonium compounds (QACs) present on a surface. In various embodiments, anionic indicators may be used to detect protonated biguanides. In various embodiments, cationic indicators, such as Toluidine blue, interact with active ingredients such as phenoxide and hypochlorite among others.

Examples of cationic indicators which may be used with the apparatus and methods described herein to indicate or detect the negative charge of an active chemical or ingredient include the following: Acridine orange, Acridine yellow, Acriflavine, Astrazon blue, Azure A, Azure B, Basic red 15, Basic red 29, Bismarck brown R, Brilliant cresyl blue ALD, Brilliant green, Brown 48, Cresyl violet, Crystal violet, Disperse blue 1, Ethyl violet, Indoine blue, Luxol brilliant green BL, Malachite green, Meldola's blue, Methyl green, Methyl violet 2B, Methyl violet 6B, Methylene blue, Methylene violet, Methylene violet 3RAX, Methylenegreen, Mordant, Mordant brown 1, New fuchsin, New Methylene blue, Nile blue, Nile red, Pyronine-G, Rhodamine 6G, Rhodamine B, Safranine O, Spirit soluble fast red 3B, Spirit soluble fast RR, Spirit soluble HLK BASF, Thioflavin T, Thionine, Toluidine Blue, Victoria blue B, Victoria blue R, Victoria green S extra, Victoria pure blue BO.

Examples of anionic indicators which may be used with the apparatus and methods described herein to indicate or detect the positive charge of an active chemical or ingredient include the following: Bromophenol Blue, Bromocresol Purple, Bromocresol Green, Bromothymol Blue, Cresci Red, Chlorophenol Red, m-Cresol purple, Thymol Blue, Erythrosine B, Alizarin Yellow R, Methyl Red, Methyl orange, Metanil Yellow, Benzopurpurin 4B, b-Naphtol Violet, Orange II, Congo Red, and Yellow 2G.

Reactivity—In various embodiments, the apparatus and methods described herein may be tailored to detect differences in chemical reactivity. For example, oxidative reactive ingredients can be indicated or detected using an indicator wipe carrying REDOX sensitive dyes capable of detecting and identifying oxidative active ingredients such as peroxide, peracetic acid, iodophors and hypochlorite among others. Examples of REDOX sensitive indicators are described in Table 5 below.

TABLE 5
REDOX Sensitive Indicators

| | | E0, V | E, V | Color of | Color of |
|---|---|---|---|---|---|
| | Indicator | at pH = 0 | at pH = 7 | Oxidized form | Reduced form |
| pH | Sodium 2,6-Dibromophenol- | 0.64 | 0.22 | blue | colorless |
| Dependent | indophenol | | | | |
| | Sodium o-Cresol indophenol | 0.62 | 0.19 | blue | colorless |
| | Thionine (syn. Lauth's violet) | 0.56 | 0.06 | violet | colorless |
| | Methylene blue | 0.53 | 0.01 | blue | colorless |
| | Indigotetrasulfonic acid | 0.37 | −0.05 | blue | colorless |
| | Indigotrisulfonic acid | 0.33 | −0.08 | blue | colorless |
| | Indigo carmine | 0.29 | −0.13 | blue | colorless |
| | Indigomono sulfonic acid | 0.26 | −0.16 | blue | colorless |
| | Phenosafranin | 0.28 | −0.25 | red | colorless |
| | Safranin T | 0.24 | −0.29 | red-violet | colorless |
| | Neutral red | 0.24 | −0.33 | red | colorless |
| pH | 2,2′-bipyridine (Ru complex) | | 1.33 | colorless | yellow |
| Independent | Nitrophenanthroline (Fe complex) | | 1.25 | cyan | red |
| | N-Phenylanthranilic acid | | 1.08 | violet-red | colorless |
| | 1,10-Phenanthroline iron(II) | | 1.06 | cyan | red |
| | sulfate complex (Ferroin) | | | | |
| | N-Ethoxychrysoidine | | 1 | red | yellow |
| | 2,2′-Bipyridine (Fe complex) | | 0.97 | cyan | red |
| | 5,6-Dimethylphenanthroline | | 0.97 | yellow-green | cyan |
| | (Fe complex) | | | | |
| | o-Dianisidine | | 0.85 | red | colorless |
| | Sodium diphenylamine sulfonate | | 0.84 | red-violet | colorless |
| | Diphenylbenzidine | | 0.76 | violet | colorless |
| | Diphenylamine | | 0.76 | violet | colorless |
| | Viologen | | −0.43 | colorless | blue |

Phenolic compounds are weak acids which undergo aromatic substitution reactions. Phenols alos readily form colorful complexes with transition metals. These properties can be utilized in the development of indicators for phenolic active ingredients. In an example, phenolic active ingredients can be indicated or detected utilizing pH sensitive indicators indicating the weak acidity of phenols or the formation of color complexes on the indicator indicating the presence of a transition metal, for example, ferric chloride forms a violet color complex of [Fe(C₆H₅O)₆]³⁻. In another example, the Bromine water test may be used where the electrophilic substitution reaction which discharges a brown color of bromine water. Examples of phenolic indicators are presented in Table 6 below.

TABLE 6
Phenolic Indicators

| Indicator | Color change |
|---|---|
| Litmus test | Blue litmus paper turns red |
| Ferric chloride test | Violet or blue |
| Libermann's test | Deep blue |
| Bromine water test | Formation of white precipitate |
| Phthalein dye test | Pink color |

In the detailed description, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, coupled or the like may include permanent (e.g., integral), removable, temporary, partial, full, and/or any other possible attachment option. Any of the components may be coupled to each other via friction, snap, sleeves, brackets, clips, or other means now known in the art or hereinafter developed. Additionally, any reference to without contact (or similar phrases) may also include reduced contact or minimal contact.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

All structural, chemical, and functional equivalents to the elements of the above-described various embodiments that are known to those of ordinary skill in the art are expressly incorporated herein by reference and are intended to be encompassed by the present claims. Moreover, it is not necessary for an apparatus or component of an apparatus, or method in using an apparatus to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a chemical, chemical composition, process, method, article, or apparatus that comprises a list of elements does not include only those elements but may include other elements not expressly listed or inherent to such chemical, chemical composition, process, method, article, or apparatus.

We claim:

1. An indicator wipe for detecting the presence of and determining the type of cationic polymer on a surface, comprising:
a substrate capable of supporting aqueous chromatography; and
an aqueous dye composition impregnated therein, the aqueous dye composition comprising a sulfonephthalein dye,
wherein the aqueous dye composition is operable to produce a cationic polymer-sulfonephthalein dye complex having a visible color,
wherein the indicator wipe is configured to be wiped over the surface for detection of the presence of the cationic polymer on the surface by the visible color, and
wherein the indicator wipe is configured to determine the type of cationic polymer present on the surface by the chromatography.

2. The indicator wipe of claim 1, wherein the pH of the aqueous dye composition impregnated into the substrate is from about 1 to about 3.

3. The indicator wipe of claim 1, wherein the pH of the aqueous dye composition impregnated into the substrate is from about 4 to about 5.

4. The indicator wipe of claim 1, wherein the substrate comprises a woven, nonwoven, or double-knit fabric, cotton, functional cellulose, or open cell foam material.

5. The indicator wipe of claim 1, wherein the substrate is a polyester nonwoven or a double-knit filament polyester cloth.

6. The indicator wipe of claim 1, wherein the sulfonephthalein dye is selected from the group consisting of bromophenol blue, bromocresol purple, bromocresol green, bromothymol blue, cresol red, chlorophenol red, m-cresol purple, thymol blue, alizarin red S, and combinations thereof.

7. The indicator wipe of claim 1, wherein the aqueous dye composition further comprises an azosulfonate, an azocarboxylate, or a bisazosulfonate dye.

8. The indicator wipe of claim 7, wherein the azosulfonate, an azocarboxylate, or a bisazosulfonate dye is selected from the group consisting of alizarin yellow R, methyl red, methyl orange, metanil yellow, benzopurpurin 4B, β-naphthol violet, orange II, congo red, yellow 2G, and combinations thereof.

9. The indicator wipe of claim 1, wherein the substrate is impregnated with the aqueous dye composition at about 0.1 g aqueous dye composition/in² substrate to about 0.5 g aqueous dye composition/in² substrate.

10. The indicator wipe of claim 1, wherein the sulfonephthalein dye is bromophenol blue, bromocresol purple, bromothymol blue, or chlorophenol red, and wherein the aqueous dye composition has a pH of about 2.

11. The indicator wipe of claim 1, wherein the cationic polymer to be detected comprises a quaternary silane.

12. A method of detecting the presence of and determining the nature of a cationic compound on a surface, the method comprising:
contacting a portion of an indicator wipe with the surface, the indicator wipe comprising: a substrate capable of supporting aqueous chromatography; and an aqueous dye composition impregnated therein, the aqueous dye composition comprising a sulfonephthalein dye, and wherein the aqueous dye composition is operable to produce a cationic compound-sulfonephthalein dye complex having a visible color; and
visually observing: (i) whether the visible color develops on the portion of the indicator wipe contacted with the surface, indicating the presence of the cationic compound on the surface; and (ii) whether the visible color moves on the substrate by aqueous chromatography into a region adjacent to the portion of the indicator wipe contacted with the surface, wherein movement indicates that the cationic compound is monomeric and wherein no movement indicates that the cationic compound is polymeric.

13. The method of claim 12, wherein the contacting comprises wiping a central region of the indicator wipe on the surface.

14. The method of claim 12, wherein no blue to blue-violet visible color on the portion of the indicator wipe contacted with the surface indicates an absence of the cationic compound on the surface.

15. The method of claim 12, wherein a blue to blue-violet visible color on the portion of the indicator wipe contacted with the surface indicates the presence of the cationic compound on the surface.

16. The method of claim 15, wherein movement of the blue to blue-violet visible color on the substrate by aqueous chromatography into a region adjacent to the portion of the indicator wipe contacted with the surface indicates that the cationic compound present on the surface is monomeric.

17. The method of claim 16, wherein the cationic compound present on the surface comprises a non-silane quaternary ammonium compound.

18. The method of claim 15, wherein no movement of the blue to blue-violet visible color on the substrate by aqueous chromatography into a region adjacent to the portion of the indicator wipe contacted with the surface indicates that the cationic compound present on the surface is polymeric.

19. The method of claim 18, wherein the polymeric cationic compound present on the surface comprises a quaternary silane.

20. The method of claim 19, wherein the quaternary silane present on the surface comprises dimethyloctadecyl[3-(trihydroxysilyl)propyl]ammonium chloride.

21. The method of claim 12, wherein an intensity of the visible color is dependent on the pH of the aqueous dye composition.

22. The method of claim 12, wherein the substrate comprises a polyester nonwoven or a double-knit filament polyester cloth.

23. The method of claim 12, wherein the sulfonephthalein dye is selected from the group consisting of bromophenol blue, bromocresol purple, bromocresol green, bromothymol blue, cresol red, chlorophenol red, m-cresol purple, thymol blue, alizarin red S, and combinations thereof.

24. The method of claim 1, wherein the aqueous dye composition further comprises an azosulfonate, an azocarboxylate, or a bisazosulfonate dye.

25. The method of claim 7, wherein the azosulfonate, an azocarboxylate, or a bisazosulfonate dye is selected from the group consisting of alizarin yellow R, methyl red, methyl orange, metanil yellow, benzopurpurin 4B, β-naphthol violet, orange II, congo red, yellow 2G, and combinations thereof.

26. An indicator wipe for detecting the presence of and determining the type of a quaternary ammonium compound on a surface, comprising:
a substrate capable of aqueous chromatography; and
an aqueous dye composition impregnated therein, the aqueous dye composition comprising a sulfonephthalein dye,
wherein the aqueous dye composition is operable to produce a quaternary ammonium-sulfonephthalein dye complex having a visible color,
wherein the indicator wipe is configured to be wiped over the surface for detection of the presence of the quaternary ammonium compound on the surface by the visible color, and
wherein the indicator wipe is configured to determine the type of quaternary ammonium compound present on the surface by the chromatography.

27. The indicator wipe of claim 26, wherein the pH of the aqueous dye composition impregnated into the substrate is from about 1 to about 3.

28. The indicator wipe of claim 26, wherein the pH of the aqueous dye composition impregnated into the substrate is from about 4 to about 5.

29. The indicator wipe of claim 26, wherein the substrate comprises a woven, nonwoven, or double-knit fabric, cotton, functional cellulose, or open cell foam material.

30. The indicator wipe of claim 26, wherein the substrate is polyester nonwoven or double-knit filament polyester cloth.

31. The indicator wipe of claim 26, wherein the sulfonephthalein dye is selected from the group consisting of bromophenol blue, bromocresol purple, bromocresol green, bromothymol blue, cresol red, chlorophenol red, m-cresol purple, thymol blue, alizarin red S, and combinations thereof.

32. The indicator wipe of claim 26, wherein the aqueous dye composition further comprises an azosulfonate, an azocarboxylate, or a bisazosulfonate dye.

33. The indicator wipe of claim 32, wherein the azosulfonate, an azocarboxylate, or a bisazosulfonate dye is selected from the group consisting of alizarin yellow R, methyl red, methyl orange, metanil yellow, benzopurpurin 4B, β-naphthol violet, orange II, congo red, yellow 2G, and combinations thereof.

34. The indicator wipe of claim 26, wherein the substrate is impregnated with the aqueous dye composition at about 0.1 g aqueous dye composition/in² substrate to about 0.5 g aqueous dye composition/in² substrate.

35. The indicator wipe of claim 26, wherein the sulfonephthalein dye is bromophenol blue, bromocresol purple, bromothymol blue, or chlorophenol red, and wherein the aqueous dye composition has a pH of about 2.

36. A method of detecting the presence of and determining the nature of a quaternary ammonium compound on a surface, the method comprising:
contacting a portion of an indicator wipe with the surface, the indicator wipe comprising: a substrate capable of aqueous chromatography; and an aqueous dye composition impregnated therein, the aqueous dye composition comprising a sulfonephthalein dye, and wherein the aqueous dye composition is operable to produce a quaternary ammonium-sulfonephthalein dye complex having a visible color; and
visually observing: (i) whether the visible color develops on the portion of the indicator wipe contacted with the surface, indicating the presence of the quaternary ammonium compound on the surface; and (ii) whether the visible color moves on the substrate by aqueous chromatography into a region adjacent to the portion of the indicator wipe contacted with the surface, wherein movement indicates that the quaternary ammonium compound is monomeric and wherein no movement indicates that the quaternary ammonium compound is polymeric.

37. The method of claim 36, wherein the contacting comprises wiping a central region of the indicator wipe on the surface.

38. The method of claim 36, wherein no blue to blue-violet visible color on the portion of the indicator wipe contacted with the surface indicates an absence of the quaternary ammonium compound on the surface.

39. The method of claim 36, wherein a blue to blue-violet visible color on the portion of the indicator wipe contacted with the surface indicates the presence of the quaternary ammonium compound on the surface.

40. The method of claim 39, wherein movement of the blue to blue-violet visible color on the substrate by aqueous chromatography into a region adjacent to the portion of the indicator wipe contacted with the surface indicates that the quaternary ammonium compound present on the surface is monomeric.

41. The method of claim 40, wherein the quaternary ammonium compound present on the surface comprises a non-silane quaternary ammonium compound.

42. The method of claim 39, wherein no movement of the blue to blue-violet visible color on the substrate by aqueous chromatography into a region adjacent to the portion of the indicator wipe contacted with the surface indicates that the quaternary ammonium compound present on the surface is polymeric.

43. The method of claim 42, wherein the quaternary ammonium compound present on the surface comprises dimethyloctadecyl[3-(trihydroxysilyl)propyl]ammonium chloride.

44. The method of claim 36, wherein an intensity of the visible color is dependent on the pH of the aqueous dye composition.

45. The method of claim 36, wherein the substrate comprises a polyester nonwoven or a double-knit filament polyester cloth.
